(19) United States
(12) Patent Application Publication
(10) Pub. No.: US 2021/0046909 A1
(43) Pub. Date: Feb. 18, 2021

(54) ELECTRIC BRAKE SYSTEM, HYDRAULIC PRESSURE CONTROL CIRCUIT, AND FLUID AMOUNT CONTROL CIRCUIT

(71) Applicant: HITACHI AUTOMOTIVE SYSTEMS, LTD., Hitachinaka-shi, Ibaraki (JP)

(72) Inventors: Suguru SAOTOME, Sagamihara-shi, Kanagawa (JP); Norikazu MATSUZAKI, Atsugi-shi, Kanagawa (JP); Masayuki KIKAWA, Aikou-gun, Kanagawa (JP); Naoki TAKAHASHI, Zama-shi, Kanagawa (JP)

(21) Appl. No.: 16/981,374

(22) PCT Filed: Feb. 20, 2019
(86) PCT No.: PCT/JP2019/006212

§ 371 Date: Sep. 16, 2020

(30) Foreign Application Priority Data
Mar. 28, 2018 (JP) 2018-062129

(51) Int. Cl. B60T 8/17; B60T 13/58; B60T 13/66

(52) U.S. Cl. CPC B60T 8/17; B60T 13/58; B60T 13/161; B60T 2270/402; B60T 2270/88; B60T 13/662

(57) ABSTRACT

An electric brake system includes a hydraulic pressure control circuit configured to acquire a detected value from a hydraulic pressure detection portion configured to detect a hydraulic pressure in a master cylinder and control driving of an electric actuator in such a manner that a target hydraulic pressure corresponding to a braking instruction is generated in the master cylinder, a fluid amount control circuit configured to drive a fluid amount supply device disposed between the master cylinder and a wheel cylinder to control a fluid amount to supply to the wheel cylinder, and a storage circuit configured to store a fluid amount characteristic, which is a characteristic of the fluid amount with respect to the detected value. The fluid amount control circuit controls the fluid amount supply device based on the fluid amount characteristic stored in the storage circuit.

### TECHNICAL FIELD

The present invention relates to an electric brake system, a hydraulic pressure control circuit, and a fluid amount control circuit that apply a braking force to a vehicle such as an automobile.

### BACKGROUND ART

An electric booster configured to use an electric actuator is known as a booster (a brake booster) mounted on a vehicle such as an automobile (PTLs 1 and 2). More specifically, PTL 1 discusses a technique that detects and determines a failure state of the electric booster by transmitting the state of the electric booster to a fluid amount supply device (an ESC) via a communication line. This technique allows a failure in the electric booster to be detected regardless of whether a brake operation is performed, and allows the fluid amount supply device to back up the electric booster when the failure is detected. PTL 2 discusses a technique that controls a motor of the electric booster according to a target hydraulic pressure value calculated based on hydraulic pressure characteristic data according to downstream stiffness.

### CITATION LIST

### Patent Literature

[PTL 1] Japanese Patent Application Public Disclosure No. 2009-045982

[PTL 2] Japanese Patent Application Public Disclosure No. 2016-193645

### SUMMARY OF INVENTION

### Technical Problem

According to the technique discussed in PTL 1, boosting control can be performed with use of the fluid amount supply device (ESC) as the backup when the failure has occurred in the electric booster. In this case, the fluid amount supply device is considered to, for example, calculate a discharge fluid amount required to generate a desired wheel cylinder pressure, and control the motor in a feed-forward manner so as to achieve this discharge fluid amount. However, the relationship between the discharge fluid amount and the hydraulic pressure (hereinafter referred to as a “fluid amount-hydraulic pressure characteristic”) may be changed due to a cause such as a caliper, a rotor, a pipe layout, an outside temperature, a fluid temperature, and an empirical pressure. This may lead to a variation in the fluid amount-hydraulic pressure characteristic, thereby reducing the accuracy of controlling the wheel cylinder pressure using the fluid amount supply device.

An object of the present invention is to provide an electric brake system, a hydraulic pressure control circuit, and a fluid amount control circuit that can improve the accuracy of controlling the wheel cylinder pressure using the fluid amount supply device (ESC).

### Solution to Problem

According to one aspect of the present invention, an electric brake system includes a hydraulic pressure control circuit configured to acquire a detected value from a hydraulic pressure detection portion configured to detect a hydraulic pressure in a master cylinder and control driving of an electric actuator in such a manner that a target hydraulic pressure corresponding to a braking instruction is generated in the master cylinder, a fluid amount control circuit configured to drive a fluid amount supply device disposed between the master cylinder and a wheel cylinder to control a fluid amount to supply to the wheel cylinder, and a storage circuit configured to store a fluid amount characteristic, which is a characteristic of the fluid amount with respect to the detected value. The fluid amount control circuit controls the fluid amount supply device based on the fluid amount characteristic stored in the storage circuit.

One aspect of the present invention is a hydraulic pressure control circuit. The hydraulic pressure control circuit is configured to acquire a detected value from a hydraulic pressure detection portion configured to detect a hydraulic pressure in a master cylinder, and control driving of an electric actuator in such a manner that a target hydraulic pressure corresponding to a braking instruction is generated in the master cylinder. The hydraulic pressure control circuit stores a fluid amount characteristic, which is a characteristic of a fluid amount with respect to the detected value, and transmits the fluid amount characteristic to a fluid amount control circuit disposed between the master cylinder and a wheel cylinder and configured to drive a fluid amount supply device.

One aspect of the present invention is a fluid amount control circuit. The fluid amount control circuit is configured to drive a fluid amount supply device disposed between a master cylinder and a wheel cylinder to control a fluid amount to supply to the wheel cylinder. The fluid amount control circuit stores a fluid amount characteristic, which is a characteristic of the fluid amount with respect to a hydraulic pressure in the master cylinder, and controls the fluid amount to supply to the wheel cylinder based on the fluid amount characteristic.

According to the above-described aspects of the present invention, it is possible to improve the accuracy of controlling the wheel cylinder pressure using the fluid amount supply device (ESC).

### BRIEF DESCRIPTION OF DRAWINGS

FIG. 1 illustrates a configuration indicating an electric brake system according to a first embodiment.

FIG. 2 illustrates a configuration indicating a communication system according to the first embodiment.

FIG. 3 is a control block diagram illustrating a master cylinder pressure control unit in FIG. 1.

FIG. 4 is a control block diagram illustrating a wheel cylinder pressure control unit in FIG. 1.

FIG. 5 illustrates a characteristic line indicating one example of a fluid amount-hydraulic pressure characteristic.

FIG. 6 illustrates processing for calculating a hydraulic pressure-fluid amount conversion coefficient for converting a hydraulic pressure characteristic value to a fluid amount characteristic value.

FIG. 7 illustrates processing for correcting a fluid amount-hydraulic pressure characteristic map based on the fluid amount characteristic value.

FIG. 8 illustrates characteristic lines indicating examples of changes in a target hydraulic pressure, a W/C pressure, a target fluid amount, and a discharge fluid amount over time between before the correction and after the correction.

FIG. 9 illustrate processing for correcting the fluid amount-hydraulic pressure characteristic map based on the hydraulic pressure characteristic value.

FIG. 10 illustrates processing for offsetting (correcting) the hydraulic pressure characteristic.

FIG. 11 is a control block diagram illustrating a master cylinder pressure control unit according to a second embodiment.

FIG. 12 illustrates processing for calculating the fluid amount characteristic value by a fluid amount-hydraulic pressure characteristic calculation portion in FIG. 11.

FIG. 13 is a flowchart illustrating processing for determining the fluid amount characteristic value by the fluid amount-hydraulic pressure characteristic calculation portion in FIG. 11.

FIG. 14 is a flowchart illustrating processing performed when a difference is large in S7 in FIG. 13.

FIG. 15 is a flowchart illustrating processing for determining whether the fluid amount-hydraulic pressure characteristic is changed or not in S10 in FIG. 13.

### DESCRIPTION OF EMBODIMENTS

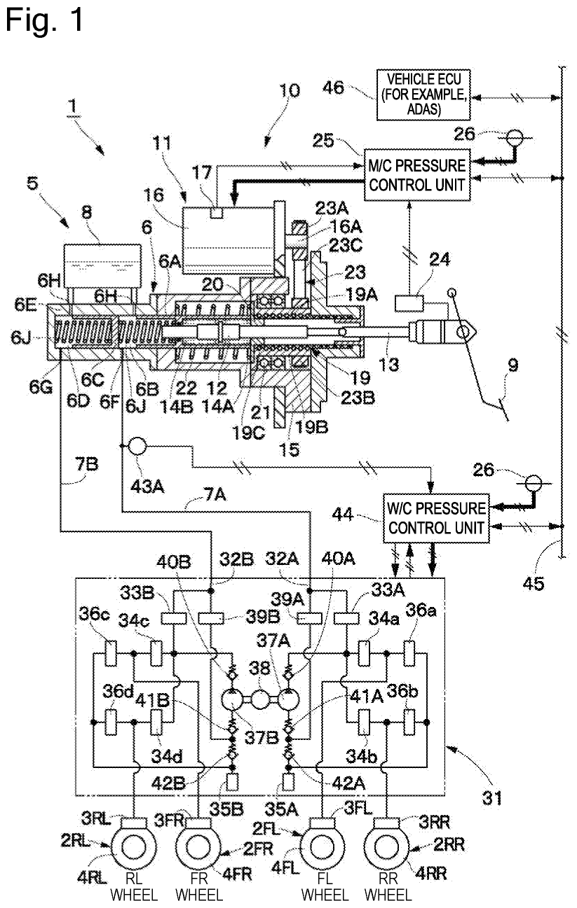

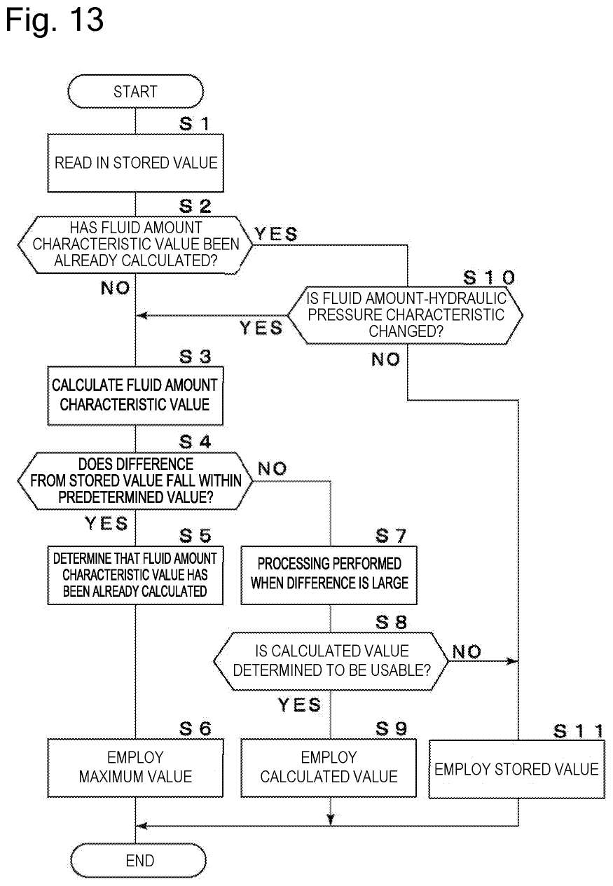

In the following description, an electric brake system, a hydraulic pressure control circuit, and a fluid amount control circuit according to embodiments will be described in detail with reference to the accompanying drawings based on an example in which they are mounted on a four-wheeled automobile. Individual steps in flowcharts illustrated in FIGS. 13 to 15 will be each represented by the symbol “S” (for example, each step will be indicated like “step 1”=“S1”). Further, a line with two slash marks added thereto in FIG. 1 indicates an electricity-related line such as a signal line (a thin line) and an electric power source line (a thick line).

FIGS. 1 to 10 illustrate a first embodiment. In FIG. 1, a brake system 1 is mounted on an automobile, which is a vehicle. The brake system 1 is used to apply braking forces to four wheels, a front left wheel (FL), a rear right wheel (RR), a front right wheel (FR), and a rear left wheel (RL). The brake system 1 includes hydraulic brake apparatuses 2FL, 2RR, 2FR, and 2RL and an electric brake control apparatus 5. The hydraulic brake apparatuses 2FL, 2RR, 2FR, and 2RL are provided as brake mechanisms mounted in correspondence with the individual wheels (FL, RR, FR, and RL), respectively. The electric brake control apparatus 5 is provided as an electric brake system that controls supply of hydraulic pressures (brake hydraulic pressures) to these hydraulic brake apparatuses 2FL, 2RR, 2FR, and 2RL. The electric brake control apparatus 5 is used to control the braking force on each of the wheels (FL, RR, FR, and RL).

The electric brake control apparatus 5 includes a master cylinder 6, a master pressure control mechanism 11, a master cylinder pressure control unit 25, a wheel cylinder pressure control mechanism 31, and a wheel cylinder pressure control unit 44. The master pressure control mechanism 11 is integrally built in the master cylinder 6. The master cylinder pressure control unit 25 is provided as a hydraulic pressure control circuit that controls actuation of the master pressure control mechanism 11. The wheel cylinder pressure control mechanism 31 is provided as a fluid amount supply device that supplies brake fluid to the hydraulic brake apparatuses 2FL, 2RR, 2FR, and 2RL. The wheel cylinder pressure control unit 44 is provided as a fluid amount control circuit that controls actuation of the wheel cylinder pressure control mechanism 31. Further, the electric brake control apparatus 5 includes a reservoir tank 8, a brake pedal 9, an input rod 13, and a brake operation amount detector 24. Electric power is supplied from a vehicle electric power source 26, which is an electric power source apparatus (a battery or an alternator) of the vehicle, to the electric brake control apparatus 5.

The hydraulic brake apparatuses 2FL, 2RR, 2FR, and 2RL are configured as hydraulic disk brakes. More specifically, the hydraulic brake apparatuses 2FL, 2RR, 2FR, and 2RL respectively include wheel cylinders 3FL, 3RR, 3FR, and 3RL each including a cylinder (a caliper), a piston, and brake pads. In each of the hydraulic brake apparatuses 2FL, 2RR, 2FR, and 2RL, the piston (a pressing member) is thrust forward by the hydraulic pressure supplied from the master pressure control mechanism 11 and/or the wheel cylinder pressure control mechanism 31. A pair of brake pads presses a disk rotor 4FL, 4RR, 4FR, or 4RL so as to sandwich it due to this forward movement of the piston.

Each of the disk rotors 4FL, 4RR, 4FR, and 4RL is configured to rotate integrally with the wheel (FL, RR, FR, or RL), and pressing the disk rotor 4FL, 4RR, 4FR, or 4RL by the pair of brake pads causes generation of a frictional braking force between them. As a result, a brake torque is applied to the disk rotor 4FL, 4RR, 4FR, or 4RL, and a braking force (a brake force) is provided between the wheel (FL, RR, FR, or RL) and the road surface. Each of the hydraulic brake apparatuses 2FL, 2RR, 2FR, and 2RL is assumed to be the hydraulic disk brake in the embodiment, but is not limited thereto, and, for example, another hydraulic brake mechanism (a hydraulic brake) such as a known hydraulic drum brake may be employed as it.

The master cylinder 6 is a tandem-type master cylinder including two pressurization chambers, a primary chamber 6B and a secondary chamber 6D. The primary chamber 6B is pressurized by a primary piston 6A (and the input piston 12). The secondary chamber 6D is pressurized by a secondary piston 6C. In this case, the primary piston 6A (and the input piston 12) is inserted on the opening side of a cylinder 6E filled with the brake fluid, and the secondary piston 6C is inserted on the bottom portion side of the cylinder 6E. Due to this configuration, in the master cylinder 6, the primary chamber 6B is formed between the primary piston 6A (and the input piston 12) and the secondary piston 6C, and the secondary chamber 6D is formed between the secondary piston 6C and the bottom portion of the cylinder 6E.

Then, a forward movement of the primary piston 6A (and the input piston 12) pressurizes the brake fluid in the primary chamber 6B, and also advances the secondary piston 6C to thus pressurize the brake fluid in the secondary chamber 6D. As a result, the brake fluid is supplied from a primary port 6F and a secondary port 6G to the hydraulic brake apparatuses 2FL, 2RR, 2FR, and 2RL (the wheel cylinders 3FL, 3RR, 3FR, and 3RL thereof) via the wheel cylinder pressure control mechanism 31. More specifically, the brake fluid pressurized in the primary chamber 6B and the secondary chamber 6D is supplied to the hydraulic brake apparatuses 2FL, 2RR, 2FR, and 2RL from a primary pipe line 7A and a secondary pipe line 7B, which are master pipe lines, via the wheel cylinder pressure control mechanism 31. As a result, the braking forces are provided to the wheels (FL, RR, FR, and RL), and a deceleration is generated on the vehicle.

The reservoir tank 8 is connected to the primary chamber 6B and the secondary chamber 6D via reservoir ports 6H and 6H of the master cylinder 6. When the primary piston 6A and the secondary piston 6C are located at their retracted positions (initial positions), the reservoir ports 6H and 6H establish communication of the primary chamber 6B and the secondary chamber 6D with the reservoir tank 8, respectively, thereby allowing the master cylinder 6 to be replenished with the brake fluid. Further, according to the forward movements of the primary piston 6A and the secondary piston 6C, the reservoir ports 6H and 6H are closed by these primary piston 6A and secondary piston 6C. As a result, the primary chamber 6B and the secondary chamber 6D are disconnected from the reservoir tank 8, which allows the primary chamber 6B and the secondary chamber 6D to be pressurized. The primary piston 6A and the secondary piston 6C are biased to their retracted positions (the original positions) by return springs 6J and 6J, respectively.

In this manner, the master cylinder 6 supplies the brake fluid to the two hydraulic circuit systems via the primary port 6F and the secondary port 6G by the two pistons, the primary piston 6A and the secondary piston 6C. Therefore, even if a failure has occurred in one of the hydraulic circuits, the brake system 1 can supply the hydraulic pressure with use of the other hydraulic circuit, thereby being able to secure the braking force.

The input piston 12, which is an input member, slidably and liquid-tightly extends through the central portion of the primary piston 6A. The front end portion of the input piston 12 is inserted in the primary chamber 6B. The input rod 13 is coupled with the rear end portion of the input piston 12. The input rod 13 extends through a housing 15 of the master pressure control mechanism 11, and extends to the outside. The brake pedal 9 is coupled with the end portion of the input rod 13. A pair of neutral springs 14A and 14B is interposed between the primary piston 6A and the input rod 12. The primary piston 6A and the input piston 12 are elastically held at their neutral positions by the spring forces of the neutral springs 14A and 14B. The spring forces of the neutral springs 14A and 14B are applied to the input piston 12 according to the axial relative position between the input piston 12 and the primary piston 6A, i.e., the positional relationship of the primary piston 6A to the input piston 12. These input piston 12 and neutral springs 14A and 14B, and the like form the master pressure control mechanism 11.

The master pressure control mechanism 11 forms an electric booster 10 together with the master cylinder pressure control unit 25. The master pressure control mechanism 11 includes an electric motor 16 for controlling a master pressure, which is the hydraulic pressure generated by the master cylinder 6. For example, the master pressure control mechanism 11 includes a piston integrated with the primary piston 6A (hereinafter referred to as the primary piston 6A), the input piston 12, the input rod 13, the pair of neutral springs 14A and 14B, the housing 15, the electric motor 16, a ball screw mechanism 19, and a belt speed reduction mechanism 23. The housing 15 forms an outer casing of the master pressure control mechanism 11. The electric motor 16 is provided as an electric actuator (an electric motor drive) that drives the primary piston 6A. The ball screw mechanism 19 is provided as a rotation-linear motion conversion mechanism disposed between the primary piston 6A and the electric motor 16. The belt speed reduction mechanism 23 is provided as a speed reduction mechanism.

Then, the primary piston 6A is disposed movably relative to the input piston 12 and the input rod 13. In the embodiment, the primary piston 6A corresponds to the piston on the primary side of the master cylinder 6 and also corresponds to the piston of the master pressure control mechanism 11. In other words, in the embodiment, the piston on the primary side of the master cylinder 6 and the piston of the master pressure control mechanism 11 are integrally formed as the primary piston 6A, which is a single piston. Further, the primary piston 6A forms the piston on the primary side of the master cylinder 6 together with the input piston 12. The brake system 1 may be configured to include the piston of the master pressure control mechanism (a power piston) and the piston on the primary side of the master cylinder (a primary piston) individually separately, although this is not illustrated.

The input piston 12 is disposed so as to extend through the central portion of the primary piston 6A, and is provided slidably and liquid-tightly in relation to the primary piston 6A. The input piston 12 is disposed in such a manner that the front end portion thereof faces the inside of the primary chamber 6B. The input rod 13 is coupled with the rear end portion of the input piston 12. The input rod 13 extends from the rear end portion of the master pressure control mechanism 11 toward the inside of the driving compartment of the vehicle body. The brake pedal 9 is coupled with the end portion of the input rod 13 on the extension side. Due to this configuration, the input rod 13 is moved forward and rearward by an operation on the brake pedal 9.

The pair of neutral springs 14A and 14B is interposed between the primary piston 6A and the input piston 12. The neutral springs 14A and 14B elastically hold the primary piston 6A and the input piston 12 at their balanced positions by the spring forces thereof. In other words, the spring forces of the neutral springs 14A and 14B are applied to the primary piston 6A and the input piston 12 according to the axial relative displacement between these primary piston 6A and input piston 12.

The electric motor 16 is the electric actuator (the electric motor drive) that moves forward and rearward the primary piston 6A. The electric motor 16 includes a rotational angle detection sensor (a rotational position sensor) 17 that detects the rotational position (the rotational angle) of the electric motor 16. The electric motor 16 is configured to be actuated according to an instruction from the master cylinder pressure control unit 25 and be able to acquire a desired rotational position. The electric motor 16 can be realized with use of, for example, a known DC motor, a DC brushless motor, or an AC motor. In the embodiment, the electric motor 16 is realized with use of the DC brushless motor in light of controllability, tranquility, durability, and the like.

The ball screw mechanism 19 includes a screw shaft 19A, a nut member 19B, and a plurality of balls 19C. The screw shaft 19A is a hollow linear motion member in which the input rod 13 is inserted. The nut member 19B is a cylindrical rotational member in which the screw shaft 19A is inserted. The plurality of balls 19C is made of steel balls loaded in a screw groove formed between the screw shaft 19A and the nut member 19B. The front end portion of the nut member 19B is in abutment with the rear end portion of the primary piston 6A via a movable member 20, and is rotatably supported via a bearing 21 provided on the housing 15. Then, the ball screw mechanism 19 rotates the nut member 19B by the electric motor 16 via the belt speed reduction mechanism 23, thereby causing the balls 19C to roll in the screw groove and thus the screw shaft 19A to linearly move. Due to this movement, the screw shaft 19A can press the primary piston 6A via the movable member 20. The screw shaft 19A is biased to the retracted position side by a return spring 22 via the movable member 20.

Another mechanism such as a rack and pinion mechanism may be used as the rotation-linear motion conversion mechanism as long as it converts the rotational motion of the electric motor 16 (i.e., the belt speed reduction mechanism 23) into the linear motion and transmits it to the primary piston 6A. Further, an electric pump or an accumulator may be used as the master pressure control mechanism 11. In other words, the electric booster 10 is not limited to the configuration using the ball screw mechanism 19, and can employ various kinds of master pressure control mechanisms such as a configuration using another mechanism such as the rack and pinion mechanism, and, further, a configuration using the electric pump or the accumulator.

The belt speed reduction mechanism 23 functions to slow down the rotation of an output shaft 16A of the electric motor 16 at a predetermined speed reduction ratio and transmits it to the ball screw mechanism 19 (the nut member 19B thereof). The belt speed reduction mechanism 23 includes a driving pulley 23A, a driven pulley 23B, and a belt 23C. The driving pulley 23A is attached to the output shaft 16A of the electric motor 16. The driven pulley 23B is attached on the outer peripheral portion of the nut member 19B of the ball screw mechanism 19. The belt 23C is wound around between them. Another speed reduction mechanism such as a gear speed reduction mechanism may be combined with the belt speed reduction mechanism 23. Further, the belt speed reduction mechanism 23 can be replaced with a known gear speed reduction mechanism, a chain speed reduction mechanism, a differential speed reduction mechanism, or the like. On the other hand, the brake system 1 may omit the speed reduction mechanism and be configured to directly drive the ball screw mechanism 19 by the electric motor 16 when a sufficiently large torque can be acquired with use of the electric motor 16. Due to this configuration, the brake system 1 can solve various problems regarding reliability, tranquility, mountability, and the like that otherwise might be raised due to the intervention of the speed reduction mechanism.

The brake operation amount detector 24 is coupled with the input rod 13. The brake operation amount detector 24 is configured as a detector (for example, a displacement sensor) that detects at least the position or the displacement amount (the stroke) of the input rod 13. Now, as the brake operation amount detector 24, the brake system 1 can employ a detector that detects the displacement amount of the input rod 13, the stroke amount of the brake pedal 9, the movement angle of the brake pedal 9, a force that presses the brake pedal 9, or a combination of this plurality of pieces of operation amount information as a brake operation amount (a physical amount) to detect. For example, the brake operation amount detector 24 may be a detector that includes a plurality of positional sensors including the displacement sensor that detects the displacement amount of the input rod 13, and a force sensor that detects the driver's force pressing the brake pedal 9. The brake operation amount detector 24 is connected to the master cylinder pressure control unit 25.

The master cylinder pressure control unit 25 includes a microcomputer, and operates by receiving electric power supplied from the vehicle electric power source 26. The master cylinder pressure control unit 25 generates the hydraulic pressure by actuating (driving) the electric motor 16 to control the position of the primary piston 6A based on the displacement amount of the brake pedal 9 (a pedal operation amount) detected by the brake operation amount detector 24. More specifically, the master cylinder pressure control unit 25 supplies an electric current to the electric motor 16 to rotationally drive the output shaft 16A of the electric motor 16 according to the displacement amount (the movement amount) of the input rod 13 due to the brake pedal 9. The rotation of the output shaft 16A is slowed down by the belt speed reduction mechanism 23, and is converted into the linear displacement of the screw shaft 19A (the displacement in the horizontal direction in FIG. 1) by the ball screw mechanism 19. The screw shaft 19A is displaced integrally with the movable member 20 and the primary piston 6A, for example, leftward as viewed in FIG. 1.

At this time, the primary piston 6A is moved forward integrally with (or displaceably relative to) the input piston 12 in the master cylinder 6. As a result, the hydraulic pressure is generated in the primary chamber 6B and the secondary chamber 6D of the master cylinder 6 according to the pressing force (the thrust force) applied from the brake pedal 9 to the input piston 12 via the input rod 13 and the thrust force applied from the electric motor 16 to the primary piston 6A. In this manner, the electric booster 10 including the master pressure control mechanism 11 and the master cylinder pressure control unit 25 moves the primary piston 6A of the master cylinder 6, which also serves as the piston of the master pressure control mechanism 11. Then, the electric booster 10 generates the hydraulic pressure in the master cylinder 6 to supply the brake fluid to the hydraulic pressure route (the primary pipe line 7A and the secondary pipe line 7B) according to the movement of the primary piston 6A.

Next, the configuration and the actuation of the wheel cylinder pressure control mechanism 31 will be described.

The wheel cylinder pressure control mechanism 31 is also referred to as the ESC (the fluid amount supply device), and is disposed between the master cylinder 6 and the hydraulic brake apparatuses 2FL, 2RR, 2FR, and 2RL (the wheel cylinders 3FL, 3RR, 3FR, and 3RL thereof). The wheel cylinder pressure control mechanism 31 controls the hydraulic pressures to supply to the hydraulic brake apparatuses 2FL, 2RR, 2FR, and 2RL (the wheel cylinders 3FL, 3RR, 3FR, and 3RL thereof). Now, the wheel cylinder pressure control mechanism 31 includes two hydraulic circuit systems formed by a first hydraulic circuit 32A and a second hydraulic circuit 32B. The first hydraulic circuit 32A is a hydraulic circuit for supplying the hydraulic pressure from the primary port 6F of the master cylinder 6 to the hydraulic brake apparatuses 2FL and 2RR of the wheels (FL and RR). The second hydraulic circuit 32B is a hydraulic circuit for supplying the hydraulic pressure from the secondary port 6G of the master cylinder 6 to the hydraulic brake apparatuses 2FR and 2RL of the wheels (FR and RL).

The first hydraulic circuit 32A and the second hydraulic circuit 32B are configured similarly to each other, and the configurations of hydraulic circuits connected to the hydraulic brake apparatuses 2FL, 2RR, 2FR, and 2RL of the individual wheels (FL, RR, FR, and RL) are configured similarly to one another. Therefore, in the following description, assume that indexes “A”, “B”, “a”, “b”, “c”, and “d” added to reference numerals correspond to the first hydraulic circuit 32A, the second hydraulic circuit 32B, the wheel (FL), the wheel (RR), the wheel (FR), and the wheel (RL), respectively.

The wheel cylinder pressure control mechanism 31 includes supply valves 33A and 33B, pressure increase valves 34a to 34d, reservoirs 35A and 35B, pressure reduction valves 36a to 36d, pumps 37A and 37B, a pump motor 38, pressurization valves 39A and 39B, check valves 40A, 40B, 41A, 41B, 42A, and 42B, and a master cylinder pressure sensor 43A.

The supply valves 33A and 33B are electromagnetic open/close valves that control the supply of the hydraulic pressures from the master cylinder 6 to the hydraulic brake apparatuses 2FL, 2RR, 2FR, and 2RL (the wheel cylinders 3FL, 3RR, 3FR, and 3RL thereof) of the individual wheels (FL, RR, FR, and RL). The pressure increase valves 34a to 34d are electromagnetic open/close valves that control the supply of the hydraulic pressures to the hydraulic brake apparatuses 2FL, 2RR, 2FR, and 2RL. The reservoirs 35A and 35B are reservoir tanks for releasing the hydraulic pressures from the hydraulic brake apparatuses 2FL, 2RR, 2FR, and 2RL. The pressure reduction valves 36a to 36d are electromagnetic open/close valves that control the release of the hydraulic pressures from the hydraulic brake apparatuses 2FL, 2RR, 2FR, and 2RL to the reservoirs 35A and 35B. The pumps 37A and 37B are hydraulic pumps for supplying the hydraulic pressures to the hydraulic brake apparatuses 2FL, 2RR, 2FR, and 2RL. The pump motor 38 is an electric motor that drives the pumps 37A and 37B. The pressurization valves 39A and 39B are electromagnetic open/close valves that control the supply of the hydraulic pressures from the master cylinder 6 to intake sides of the pumps 37A and 37B. The check valves 40A, 40B, 41A, 41B, 42A, and 42B prohibit a backward flow from the downstream side to the upstream side of the pumps 37A and 37B.

The master cylinder pressure sensor 43A detects the hydraulic pressure at the primary port 6F of the master cylinder 6. In other words, the master cylinder pressure sensor 43A is a hydraulic pressure detection portion that detects the hydraulic pressure in the master cylinder 6. The master cylinder pressure sensor 43A is provided in the primary pipe line 7A, which is the master pipe line on the primary side. The master cylinder pressure sensor 43A is a pressure sensor (a hydraulic pressure sensor) that detects the master pressure, and is connected to the wheel cylinder pressure control unit 44. The master cylinder pressure sensor 43A can be, for example, built in the wheel cylinder pressure control mechanism 31.

The actuation of the wheel cylinder pressure control mechanism 31, i.e., the actuation of the supply valves 33A and 33B, the pressure increase valves 34a to 34d, the pressure reduction valves 36a to 36d, the pressurization valves 39A and 39B, and the pump motor 38 are controlled by the wheel cylinder pressure control unit 44. At this time, the wheel cylinder pressure control unit 44 supplies the hydraulic pressures from the master cylinder 6 to the hydraulic brake apparatuses 2FL, 2RR, 2FR, and 2RL of the individual wheels (FL, RR, FR, and RL) by opening the supply valves 33A and 33B and the pressure increase valves 34a to 34d and closing the pressure reduction valves 36a to 36d and the pressurization valves 39A and 39B. Further, the wheel cylinder pressure control unit 44 releases the hydraulic pressures in the hydraulic brake apparatuses 2FL, 2RR, 2FR, and 2RL to the reservoirs 35A and 35B to reduce the pressures by opening the pressure reduction valves 36a to 36d, the supply valves 33A and 33B, the pressure increase valves 34a to 34d, and the pressurization valves 39A and 39B.

Further, the wheel cylinder pressure control unit 44 maintains the hydraulic pressures in the hydraulic brake apparatuses 2FL, 2RR, 2FR, and 2RL by closing the pressure increase valves 34a to 34d and the pressure reduction valves 36a to 36d. Further, the wheel cylinder pressure control unit 44 increases the hydraulic pressures in the hydraulic brake apparatuses 2FL, 2RR, 2FR, and 2RL independently of the hydraulic pressure in the master cylinder 6 by opening the pressure increase valves 34a to 34d and closing the supply valves 33A and 33B, the pressure reduction valves 36a to 36d, and the pressurization valves 39A and 39B, and also actuating the pump motor 38. Further, the wheel cylinder pressure control unit 44 further pressurizes the hydraulic pressures transmitted from the master cylinder 6 with use of the pumps 37A and 37B to supply them to the hydraulic brake apparatuses 2FL, 2RR, 2FR, and 2RL by opening the pressurization valves 39A and 39B and the pressure increase valves 34a to 34d and closing the pressure reduction valves 36a to 36d and the supply valves 33A and 33B, and also actuating the pump motor 38.

In this manner, the actuation of the wheel cylinder pressure control mechanism 31 is controlled by the wheel cylinder pressure control unit 44. More specifically, the wheel cylinder pressure control unit 44 drives the wheel cylinder pressure control mechanism 31 to control the fluid amounts to supply to the wheel cylinders 3FL, 3RR, 3FR, and 3RL of the hydraulic brake apparatuses 2FL, 2RR, 2FR, and 2RL. The wheel cylinder pressure control unit 44 includes a microcomputer, and operates by receiving electric power supplied from the vehicle electric power source 26. The wheel cylinder pressure control unit 44 calculates a target brake force that should be generated on each of the wheels (FL, RR, FR, and RL) based on a vehicle state amount and controls the wheel cylinder pressure control mechanism 31 based on this calculated value. The wheel cylinder pressure control mechanism 31 receives the brake fluid pressurized by the master cylinder 6 and controls the brake hydraulic pressures (wheel pressures) to supply to the wheel cylinders 3FL, 3RR, 3FR, and 3RL of the individual wheels (FL, RR, FR, and RL) according to the output from the wheel cylinder pressure control unit 44, thereby performing various types of brake control.

In this case, the wheel cylinder pressure control unit 44 can perform, for example, the following types of control (1) to (8) by controlling the actuation of the wheel cylinder pressure control mechanism 31. (1) Braking force distribution control of appropriately distributing the braking force to each of the wheels (FL, RR, FR, and RL) according to a vertical load and the like when the vehicle is braked. (2) Anti-lock brake control of preventing each of the wheels (FL, RR, FR, and RL) from being locked (slipped) by automatically adjusting the braking force provided to each of the wheels (FL, RR, FR, and RL) when the vehicle is braked. (3) Vehicle stabilization control of suppressing understeer and oversteer to stabilize a behavior of the vehicle by detecting a sideslip of each of the wheels (FL, RR, FR, and RL) when the vehicle is running and appropriately automatically controlling the braking force to apply to each of the wheels (FL, RR, FR, and RL). (4) Hill start aid (HSA) control of aiding a start by maintaining a braked state on a slope (especially, an ascending slope). (5) Traction control of preventing each of the wheels (FL, RR, FR, and RL) from idly spinning, for example, when the vehicle starts running. (6) Preceding vehicle following control of maintaining a constant distance to a preceding vehicle. (7) Traffic lane departure avoidance control of maintaining the vehicle within a traffic lane. (8) Obstacle avoidance control of avoiding a collision with an obstacle in front of or behind the vehicle (autonomous brake control or collision damage mitigation brake control).

A known hydraulic pump such as a plunger pump, a trochoid pump, and a gear pump can be used as the pumps 37A and 37B of the wheel cylinder pressure control mechanism 31, but it is desirable to use the gear pump in light of mountability to the vehicle, tranquility, pump efficiency, and the like. A known motor such as a DC motor, a DC brushless motor, and an AC motor can be used as the electric motor 38, but it is desirable to use the DC brushless motor from the viewpoint of controllability, tranquility, durability, mountability to the vehicle, and the like.

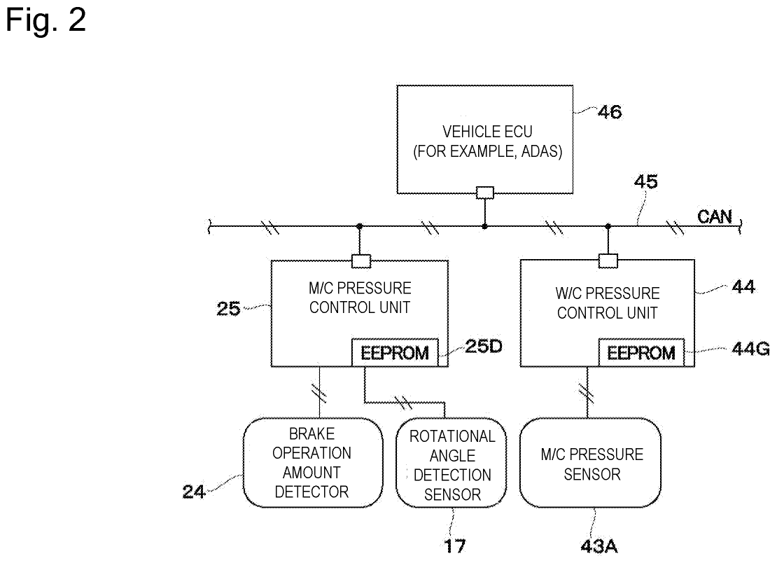

As illustrated in FIG. 2, the brake operation amount detector 24 and the rotational angle detection sensor 17 are connected to the master cylinder pressure control unit 25. The master cylinder pressure sensor 43A is connected to the wheel cylinder pressure control unit 44. The information acquired from the master cylinder pressure sensor 43A is transmitted to the master cylinder pressure control unit 25 via CAN communication. As a result, the master cylinder pressure control unit 25 can acquire the detected value from the master cylinder pressure sensor 43A. As will be described below, the master cylinder pressure control unit 25 controls the master cylinder pressure based on the information acquired from these brake operation amount detector 24, rotational angle detection sensor 17, and master cylinder pressure sensor 43A.

To fulfill this function, the master cylinder pressure control unit 25 and the wheel cylinder pressure control unit 44 are connected to each other via a vehicle data bus 45 therebetween. The vehicle data bus 45 is a communication network between vehicle ECUs (a communication network between apparatuses) called a CAN that is mounted on the vehicle. More specifically, the vehicle data bus 45 is a serial communication portion that establishes multiplex communication among a large number of electronic apparatuses (ECUs: Electronic Control Units) mounted on the vehicle. Due to this configuration, information is transmitted and received via the CAN communication between the master cylinder pressure control unit 25 and the wheel cylinder pressure control unit 44. More specifically, for example, “values measured by various kinds of sensors (detected values)”, a “request to actuate, for example, the vehicle stabilization control including anti-skid control and sideslip prevention), and an “abnormal state” are transmitted reciprocally between the master cylinder pressure control unit 25 and the wheel cylinder pressure control unit 44.

Further, the master cylinder pressure control unit 25 and the wheel cylinder pressure control unit 44 also carry out CAN communication via the vehicle data bus 45 with a vehicle ECU 46, which is a different ECU from them, such as an ADAS (Advanced Driver Assistance Systems). An autonomous brake target hydraulic pressure or the like is transmitted from the vehicle ECU 46 to the master cylinder pressure control unit 25 and the wheel cylinder pressure control unit 44. The brake system 1 is assumed to be configured in such a manner that the wheel cylinder pressure control unit 44 introduces therein the information acquired from the master cylinder pressure sensor 43A in the embodiment, but may be configured in such a manner that the master cylinder pressure control unit 25 introduces it therein. Alternatively, the brake system 1 may be configured in such a manner that the vehicle ECU 46 such as the ADAS introduces it therein and transmits it to the master cylinder pressure control unit 25 via the CAN communication.

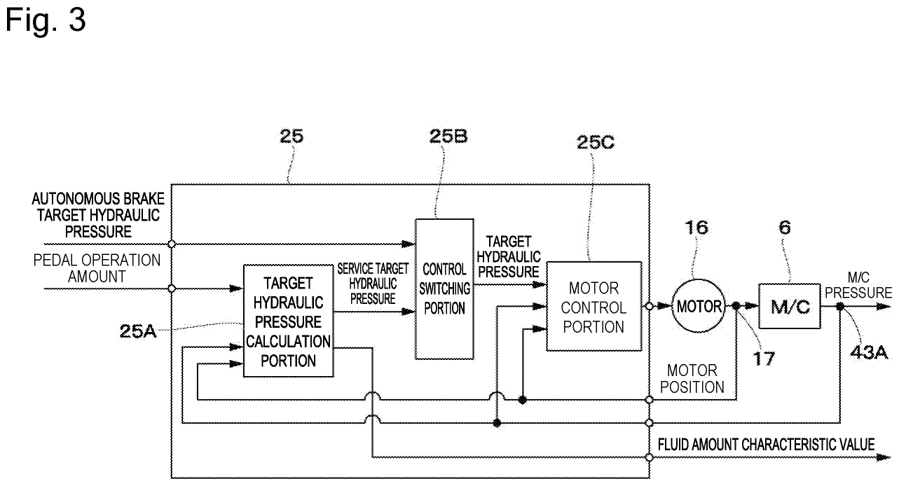

Next, the control of the master cylinder pressure by the master cylinder pressure control unit 25 will be described with reference to FIG. 3.

The master cylinder pressure control unit 25 includes a target hydraulic pressure calculation portion 25A, a control switching portion 25B, and a motor control portion 25C. The master cylinder pressure control unit 25 calculates a service target hydraulic pressure by the target hydraulic pressure calculation portion 25A based on the pedal operation amount (the displacement amount, the pressing force, or the like) detected by the brake operation amount detector 24. Now, a “fluid amount-hydraulic pressure characteristic” is defined to refer to the characteristic of the master cylinder pressure (the hydraulic pressure) generated with respect to the amount of the brake fluid (the fluid amount) that the master cylinder 6 transmits downstream by the input piston 12 and the primary piston 6A. In this case, the fluid amount-hydraulic pressure characteristic is changed due to a cause such as the caliper, the rotor, the pipe layout, the outside temperature, the fluid temperature, and the empirical pressure. This means that the movement amount of the primary piston 6A with respect to the pedal operation amount is also changed according to the change in the fluid amount-hydraulic pressure characteristic, assuming that the characteristic of the service target hydraulic pressure with respect to the pedal operation amount is constant.

Therefore, when there is a limit on the movement amount of the primary piston 6A relative to the input piston 12, an infeasible service target hydraulic pressure may be calculated. With the aim of dealing with this inconvenience, in PTL 2, the target hydraulic pressure calculation portion 25A calculates a feasible service target hydraulic pressure by storing in advance a hydraulic pressure difference between a “preset nominal fluid amount-hydraulic pressure characteristic map” and a “characteristic of the master cylinder pressure generated with respect to the amount of the brake fluid that the master cylinder 6 actually transmits downstream by the input piston 12 and the primary piston 6A”, and offsetting the service target hydraulic pressure with respect to the pedal operation amount based on this hydraulic pressure difference.

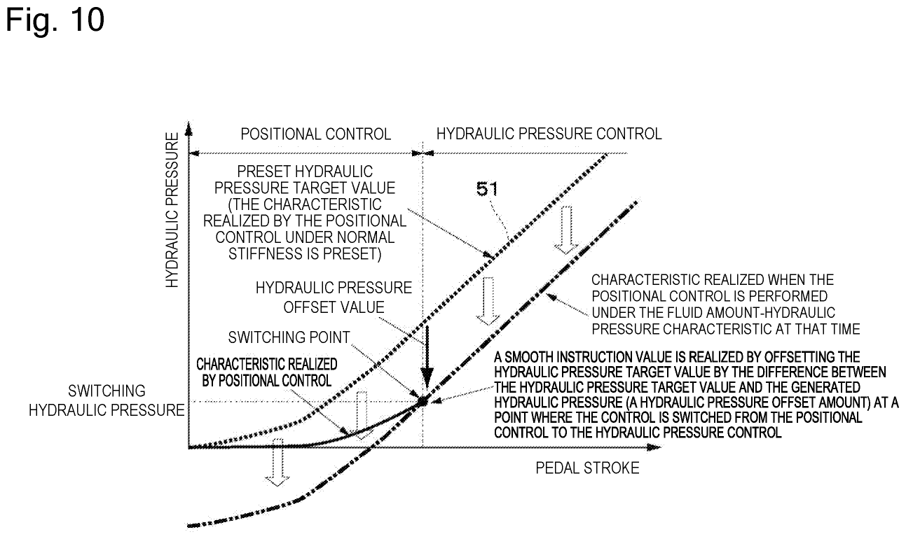

More specifically, the target hydraulic pressure calculation portion 25A calculates the service target hydraulic pressure by offsetting a preset hydraulic pressure target value 51 based on the hydraulic pressure difference (a hydraulic pressure offset value) as illustrated in FIG. 10. As will be described below, in the embodiment, because the hydraulic pressure difference (the hydraulic pressure offset value) is correlated with the fluid amount-hydraulic pressure characteristic, this hydraulic pressure offset value (a hydraulic pressure characteristic value ΔP) is converted into a fluid amount offset value (a fluid amount characteristic value ΔQ), and a target fluid amount calculated by the wheel cylinder pressure control unit 44 (a target fluid amount calculation portion 44A thereof) is corrected based on this fluid amount offset value.

The service target hydraulic pressure calculated by the target hydraulic pressure calculation portion 25A is input to the control switching portion 25B. The control switching portion 25B selects one of the service target hydraulic pressure calculated in the above-described manner and the autonomous brake target hydraulic pressure received from the vehicle ECU 46 via the CAN communication by, for example, selecting the higher one, and sets the selected hydraulic pressure as the target hydraulic pressure. The target hydraulic pressure is output to the motor control portion 25C. Then, the motor control portion 25C calculates a target motor position based on the difference between the target hydraulic pressure and the master cylinder pressure and performs feedback control with use of the motor position measured by the rotational angle detection sensor 17, thereby controlling the master cylinder pressure. In this manner, the master cylinder pressure control unit 25 controls the driving of the electric motor 16 in such a manner that the master cylinder 6 generates the target hydraulic pressure corresponding to a braking instruction (the pedal operation amount detected by the brake operation amount detector 24 or the autonomous brake instruction output from the vehicle ECU 46).

While the master pressure control mechanism 11 is normally operating, the master cylinder pressure can be controlled in the above-described manner. However, when an abnormality has occurred in the master pressure control mechanism 11 and the master pressure control mechanism 11 cannot perform the boosting control, the wheel cylinder pressure control mechanism 31 is substituted for the boosting as a backup.

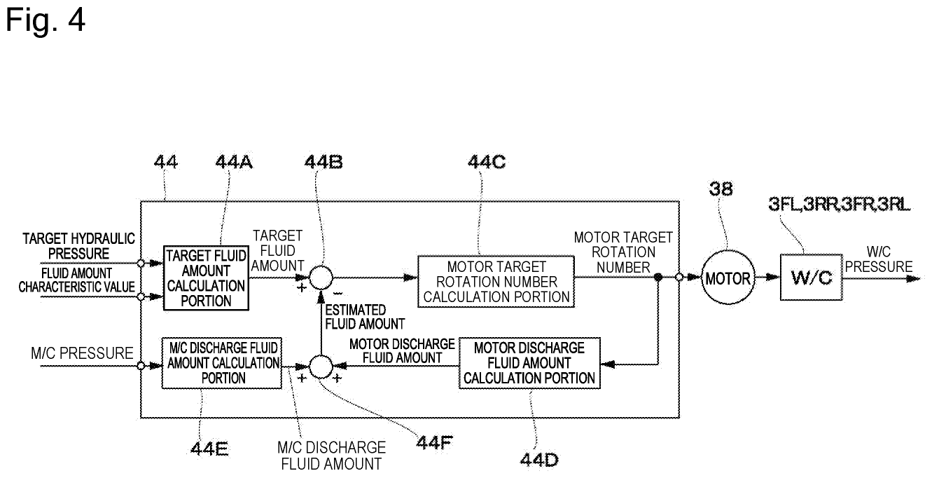

Next, the control of the wheel cylinder pressure control mechanism 31 by the wheel cylinder pressure control unit 44, and more specifically, the boosting control by the wheel cylinder pressure control unit 44 will be described with reference to FIG. 4.

The wheel cylinder pressure control unit 44 includes the target fluid amount calculation portion 44A, a subtraction portion 44B, a motor target rotation number calculation portion 44C, a motor discharge fluid amount calculation portion 44D, a master cylinder discharge fluid amount calculation portion 44E, and an addition portion 44F. The wheel cylinder pressure control unit 44 converts the target hydraulic pressure into the target fluid amount by the target fluid amount calculation portion 44A. For example, the target hydraulic pressure output from the control switching portion 25B of the master cylinder pressure control unit 25 is input to the target fluid amount calculation portion 44A. Now, the target hydraulic pressure may be transmitted from the master cylinder pressure control unit 25, but there is a possibility that this transmission is impossible when an abnormality has occurred in the master cylinder pressure control unit 25. For this reason, it is desirable that the brake system 1 is configured in such a manner that, for example, the wheel cylinder pressure control unit 44 directly measures the signal of the brake operation amount detector 24 and calculates the target hydraulic pressure. Alternatively, it is desirable that the brake system 1 is configured in such a manner that the vehicle ECU 46 directly measures the signal of the brake operation amount detector 24 and transmits the measured signal to the wheel cylinder pressure control unit 44 via the CAN communication (the vehicle data bus 45).

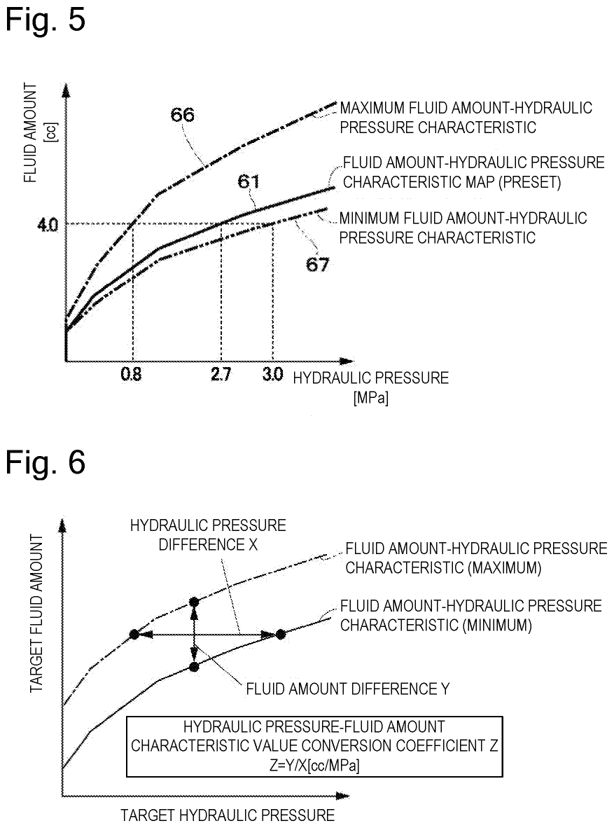

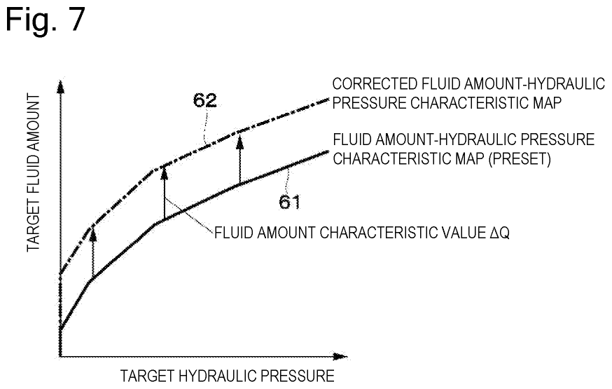

In any case, the target hydraulic pressure is input to the target fluid amount calculation portion 44A of the wheel cylinder pressure control unit 44, for example, when an abnormality has occurred in the wheel cylinder pressure control mechanism 31. The target fluid amount calculation portion 44A converts the target hydraulic pressure into the target fluid amount. In this case, for example, the characteristic of the wheel cylinder pressure generated with respect to the discharge amount of the brake fluid by the wheel cylinder pressure control mechanism 31 (the fluid amount-hydraulic pressure characteristic) is set to the target fluid amount calculation portion 44A in advance as a map (for example, a fluid amount-hydraulic pressure characteristic map 61 illustrated in FIGS. 5 and 7). In other words, the target fluid amount calculation portion 44A calculates the target fluid amount based on the target hydraulic pressure with use of the preset map (the fluid amount-hydraulic pressure characteristic map 61). The subtraction portion 44B substrates an estimated fluid amount, which will be descried below, from the target fluid amount calculated by the target fluid amount calculation portion 44A. The difference between the target fluid amount and the estimated fluid amount that is calculated by the subtraction portion 44B is input to the motor target rotation number calculation portion 44C. The motor target rotation number calculation portion 44C calculates, based on the difference between the target fluid amount and the estimated fluid amount, a motor target rotation number required to solve this fluid amount difference, thereby driving the motor (the pump motor 38). As a result, the wheel cylinder pressures are generated in the wheel cylinders 3FL, 3RR, 3FR, and 3RL according to the brake fluid discharge amount based on the driving of the motor (the pump motor 38).

On the other hand, the motor discharge fluid amount calculation portion 44D calculates a motor discharge fluid amount, which is the brake fluid amount discharged according to the rotation of the motor (the pump motor 38), based on the motor target rotation number calculated by the motor target rotation number calculation portion 44C. Now, if the fluid amounts flowing into the wheel cylinders 3FL, 3RR, 3FR, and 3RL entirely stem from the fluid amount discharged from the motor (the pump motor 38), the fluid amounts flowing into the wheel cylinders 3FL, 3RR, 3FR, and 3RL could be estimated by the motor discharge fluid amount calculation portion 44D alone. However, supposing that an abnormality has occurred while the master pressure control mechanism 11 generates the master cylinder pressure, this leads to a start of the control by the wheel cylinder pressure control unit 44 with the fluid amount discharged by the master cylinder 6 also supplied in the wheel cylinders 3FL, 3RR, 3FR, and 3RL in advance. Therefore, the master cylinder discharge fluid amount calculation portion 44E calculates the master cylinder discharge fluid amount, which is the fluid amount discharged by the master cylinder 6, based on the master cylinder pressure immediately before the abnormality has occurred in the master pressure control mechanism 11. Then, the addition portion 44F adds the master cylinder discharge fluid amount calculated by the master cylinder discharge fluid amount calculation portion 44E and the motor discharge fluid amount calculated by the motor discharge fluid amount calculation portion 44D. The value calculated by the addition portion 44F, i.e., a value acquired by adding the motor discharge fluid amount to the master cylinder discharge fluid amount is set as the estimated fluid amount. The estimated fluid amount is input from the addition portion 44F to the subtraction portion 44B.

In this manner, even when an abnormality has occurred in the master pressure control mechanism 11, the boosting control can be performed with use of the wheel cylinder pressure control mechanism 31 as the backup. However, a variation may occur in the characteristic of the wheel cylinder pressure generated with respect to the amount of the fluid flowing into each of the wheel cylinders 3FL, 3RR, 3FR, and 3RL (the fluid amount-hydraulic pressure characteristic) due to a cause such as the caliper, the rotor, the pipe layout, the outside temperature, the fluid temperature, and the empirical pressure, i.e., a disturbance factor. On the other hand, when the wheel cylinder pressure is controlled in the wheel cylinder pressure control mechanism 31 by the wheel cylinder pressure control unit 44 in the above-described manner, the wheel cylinder pressure is controlled in a feed-forward manner based on the preset fluid amount-hydraulic pressure characteristic map (the fluid amount-hydraulic pressure characteristic map 61). Therefore, when attempting to generate, for example, a target hydraulic pressure 2.7 MPa as illustrated in FIG. 5, the wheel cylinder pressure control unit 44 controls the motor (the pump motor 38) in such a manner that the motor discharge fluid amount matches 4 cc according to the preset fluid amount-hydraulic pressure characteristic map 61. However, actually, the fluid amount-hydraulic pressure characteristic is changed between a maximum fluid amount-hydraulic pressure characteristic 66 and a minimum fluid amount-hydraulic pressure characteristic 67 as illustrated in FIG. 5 due to the above-described disturbance factor. Therefore, the generated wheel cylinder pressure is also changed between 0.8 MPa and 3.0 MPa, and the desired wheel cylinder pressure may be unable to be acquired.

In this manner, when a variation has occurred in the fluid amount-hydraulic pressure characteristic, this variation also leads to a variation in the wheel cylinder pressure realized based thereon, thereby raising a possibility of reducing the control accuracy. Especially, when a failure has occurred in the electric booster 10 while the vehicle is running based on the autonomous driving function, the autonomous brake should continue with use of the wheel cylinder pressure control mechanism 31 until the driver (the operator) becomes able to drive the vehicle. This makes it further important to secure the accuracy of controlling the wheel cylinder pressure during the backup. To address this issue, one exemplary possible measure for improving the accuracy of controlling the wheel cylinder pressure is to additionally provide another wheel cylinder pressure sensor and perform feedback control. However, it is impractical in light of cost to additionally provide another sensor only to use at the time of the backup.

Under these circumstances, in the embodiment, when a variation has occurred in the fluid amount-hydraulic pressure characteristic, the target fluid amount is corrected so as to eliminate the variation to improve the accuracy of controlling the wheel cylinder pressure. More specifically, in the embodiment, the accuracy of controlling the wheel cylinder pressure is improved by correcting the fluid amount-hydraulic pressure characteristic map (the fluid amount-hydraulic pressure characteristic map 61) used when the target hydraulic pressure is converted into the target fluid amount so as to make it closer to the actual fluid amount-hydraulic pressure characteristic with use of the fluid amount characteristic value ΔQ, which will be described below.

More specifically, the target hydraulic pressure calculation portion 25A of the master cylinder pressure control unit 25 illustrated in FIG. 3 calculates the fluid amount characteristic value ΔQ by setting the hydraulic pressure difference (the hydraulic pressure offset value) between the “nominal fluid amount-hydraulic pressure characteristic” and the “actual fluid amount-hydraulic pressure characteristic” used when the service target hydraulic pressure is calculated as the hydraulic pressure characteristic value ΔP, and converting this hydraulic pressure characteristic value ΔP based on a hydraulic pressure-fluid amount conversion coefficient Z, which will be described below. In other words, the target hydraulic pressure calculation portion 25A calculates the fluid amount characteristic value ΔQ by converting the hydraulic pressure characteristic value ΔP corresponding to the hydraulic pressure offset value illustrated in FIG. 10 based on the hydraulic pressure-fluid amount conversion coefficient Z. The hydraulic pressure-fluid amount conversion coefficient Z illustrated in FIG. 6 is used to convert the hydraulic pressure characteristic value ΔP into the fluid amount characteristic value ΔQ. In this case, as illustrated in FIG. 6, a hydraulic pressure difference X and a fluid amount difference Y are calculated with use of the maximum fluid amount-hydraulic pressure characteristic and the minimum fluid amount-hydraulic pressure characteristic, and a ratio between them is set as the hydraulic pressure-fluid amount conversion coefficient Z. More specifically, the hydraulic pressure-fluid amount conversion coefficient Z can be calculated with use of the following equation 1, assuming that X and Y represent the hydraulic pressure difference between the maximum fluid amount-hydraulic pressure characteristic and the minimum fluid amount-hydraulic pressure characteristic, and the fluid amount difference between the maximum fluid amount-hydraulic pressure characteristic and the minimum fluid amount-hydraulic pressure characteristic, respectively.

Z=Y/X [EQUATION 1]

In the embodiment, the target hydraulic pressure calculation portion 25A calculates the fluid amount characteristic value ΔQ by multiplying the hydraulic pressure characteristic value ΔP by the hydraulic pressure-fluid amount conversion coefficient Z. More specifically, the fluid amount characteristic value ΔQ is calculated from the hydraulic pressure characteristic value ΔP and the hydraulic pressure-fluid amount conversion coefficient Z with use of the following equation 2.

ΔQ=Z×ΔP [Equation 2]

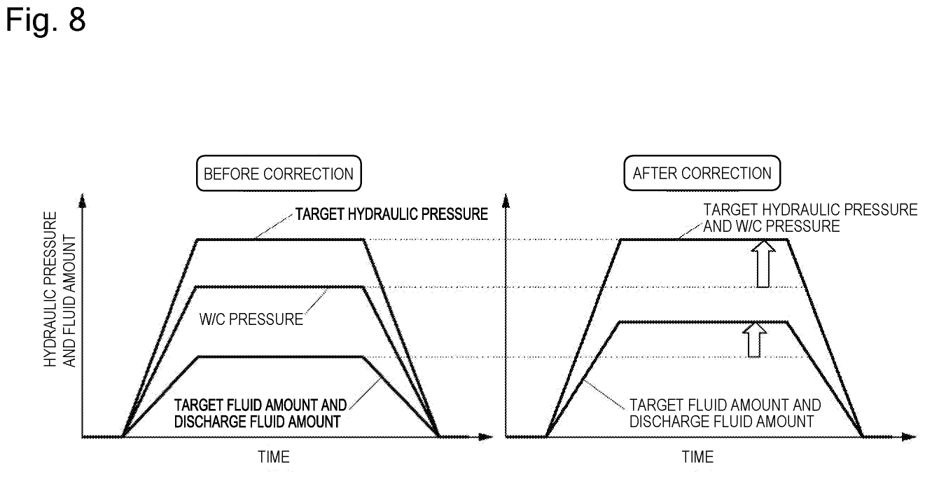

The target hydraulic pressure calculation portion 25A outputs the fluid amount characteristic value ΔQ to the target fluid amount calculation portion 44A of the wheel cylinder pressure control unit 44. The target fluid amount calculation portion 44A calculates the target fluid amount according to the actual fluid amount-hydraulic pressure characteristic by correcting the preset fluid amount-hydraulic pressure characteristic map 61 in a direction of a fluid amount axis as illustrated in FIG. 7 with use of the fluid amount characteristic value ΔQ. More specifically, the target fluid amount calculation portion 44A corrects the fluid amount-hydraulic pressure characteristic map 61 into a corrected fluid amount-hydraulic pressure characteristic map 62 with use of the fluid amount characteristic value ΔQ, and converts the target hydraulic pressure into the target fluid amount based on this corrected fluid amount-hydraulic pressure characteristic map 62. Then, the wheel cylinder pressure control unit 44 controls the motor (the pump motor 38) of the wheel cylinder pressure control mechanism 31 in a similar manner to the control before the correction with use of the corrected target fluid amount. Due to this control, the accuracy of controlling the wheel cylinder pressure can be improved by changing the discharge fluid amount with respect to the same target hydraulic pressure as illustrated in a timing chart of FIG. 8. More specifically, while the actual wheel cylinder pressure (the W/C pressure) deviates from the target hydraulic pressure before the correction (when the fluid amount-hydraulic pressure characteristic map 61 is used), the deviation of the wheel cylinder pressure (the W/C pressure) from the target hydraulic pressure can be solved after the correction (when the corrected fluid amount-hydraulic pressure characteristic map 62 is used).

In this manner, in the embodiment, the master cylinder pressure control unit 25 converts the hydraulic pressure characteristic value ΔP (the hydraulic pressure offset value) used by the target hydraulic pressure calculation portion 25A into the fluid amount characteristic value ΔQ (the fluid amount offset value) based on the hydraulic pressure-fluid amount conversion coefficient Z. The master cylinder pressure control unit 25 transmits (outputs) the fluid amount characteristic value ΔQ to the wheel cylinder pressure control unit 44. This transmission (output) of the fluid amount characteristic value ΔQ may be, for example, carried out constantly, carried out each time the brake operation is performed, carried out regularly each time a predetermined time has elapsed, or carried out when (or immediately before) an abnormality has occurred in the master pressure control mechanism 11. On the other hand, the target fluid amount calculation portion 44A of the wheel cylinder pressure control unit 44 corrects the fluid amount-hydraulic pressure characteristic map 61 in the direction of the fluid amount axis with use of the fluid amount characteristic value ΔQ (the fluid amount offset value). Then, the wheel cylinder pressure control unit 44 controls the wheel cylinder pressure control mechanism 31 (the pump motor 38) with use of the corrected fluid amount-hydraulic pressure characteristic map (the corrected fluid amount-hydraulic pressure characteristic map 62).

To fulfill this function, in the embodiment, the master cylinder pressure control unit 25 as the hydraulic pressure control circuit includes a memory 25D provided as a storage circuit, as illustrated in FIG. 2. The memory 25D can be embodied with use of, for example, a flash memory, a ROM, a RAM, or an EEPROM. In the embodiment, the memory 25D includes the EEPROM, which is a nonvolatile storage device (memory) capable of retaining the storage even when electric power is not supplied thereto. The memory 25D stores therein the fluid amount characteristic, which is the characteristic of the fluid amount with respect to the value detected by the master cylinder pressure sensor 43A as the hydraulic pressure detection portion. More specifically, the memory 25D of the master cylinder pressure control unit 25 updatably stores therein the actual fluid amount-hydraulic pressure characteristic, the hydraulic pressure characteristic value ΔP, the hydraulic pressure-fluid amount conversion coefficient Z, the fluid amount characteristic value ΔQ, and the like, in addition to storing therein the nominal fluid amount-hydraulic pressure characteristic used to calculate the service target hydraulic pressure by the target hydraulic pressure calculation portion 25A (for example, the hydraulic pressure target value 51 illustrated in FIG. 10) in advance.

Further, as illustrated in FIG. 2, the wheel cylinder pressure control unit 44 as the fluid amount control circuit includes a memory 44G provided as a storage circuit. The memory 44G can be embodied with use of, for example, a flash memory, a ROM, a RAM, or an EEPROM. In the embodiment, the memory 44G includes the EEPROM, which is a nonvolatile storage device (memory) capable of retaining the storage even when electric power is not supplied thereto. The memory 44G stores therein the fluid amount characteristic, which is the characteristic of the fluid amount with respect to the value detected by the master cylinder pressure sensor 43A. More specifically, the memory 44G of the wheel cylinder pressure control unit 44 updatably stores therein the fluid amount characteristic value ΔQ and the like transmitted (output) from the master cylinder pressure control unit 25 (the target hydraulic pressure calculation portion 25A), in addition to storing therein the fluid amount-hydraulic pressure characteristic map used to calculate the target fluid amount by the target fluid amount calculation portion 44A (for example, the fluid amount-hydraulic pressure characteristic map 61 illustrated in FIG. 7) in advance.

Then, the wheel cylinder pressure control unit 44 controls the wheel cylinder pressure control mechanism 31 as the fluid amount supply device based on the fluid amount characteristic stored in the memory 44G (the fluid amount characteristic value ΔQ), and more specifically, based on the fluid amount-hydraulic pressure characteristic (the corrected fluid amount-hydraulic pressure characteristic map 62) corrected based on the fluid amount characteristic (the fluid amount characteristic value ΔQ). More specifically, the wheel cylinder pressure control unit 44 (updatably) stores the fluid amount characteristic (the fluid amount characteristic value ΔQ), which is the characteristic of the fluid amount with respect to the hydraulic pressure of the master cylinder 6, and controls the fluid amount to supply to each of the wheel cylinders 3FL, 3RR, 3FR, and 3RL based on this fluid amount characteristic (i.e., the corrected fluid amount-hydraulic pressure characteristic map 62 corrected based on the fluid amount characteristic value ΔQ). In this case, the wheel cylinder pressure control unit 44 controls the wheel cylinder pressure control mechanism 31 based on the fluid amount characteristic stored in the memory 44G (the fluid amount-hydraulic pressure characteristic corrected based on the fluid amount characteristic value ΔQ), for example, when the hydraulic pressure corresponding to the braking instruction (the autonomous brake instruction or the pedal operation amount) cannot be generated with use of the electric motor 16 of the master pressure control mechanism 11. In other words, the wheel cylinder pressure control unit 44 controls the fluid amount to supply to each of the wheel cylinders 3FL, 3RR, 3FR, and 3RL based on the fluid amount characteristic (the corrected fluid amount-hydraulic pressure characteristic map 62) when the hydraulic pressure corresponding to the braking instruction cannot be generated with use of the electric motor 16.

On the other hand, the master cylinder pressure control unit 25 (updatably) stores the fluid amount characteristic (the fluid amount characteristic value ΔQ), and transmits this fluid amount characteristic (the fluid amount characteristic value ΔQ) to the wheel cylinder pressure control unit 44, which drives (controls) the wheel cylinder pressure control mechanism 31. In this case, the master cylinder pressure control unit 25 transmits the fluid amount characteristic (the fluid amount characteristic value ΔQ) to the wheel cylinder pressure control unit 44, for example, when the hydraulic pressure corresponding to the braking instruction (the autonomous brake instruction or the pedal operation amount) cannot be generated with use of the electric motor 16 of the master pressure control mechanism 11.

The wheel cylinder pressure control unit 44 stores the fluid amount characteristic (the fluid amount characteristic value ΔQ) into the memory 44G. In this case, a fluid amount characteristic when the wheel cylinder pressure control unit 44 (or the master cylinder pressure control unit 25) has been started up last time is stored in the nonvolatile memory as the fluid amount characteristic (the fluid amount characteristic value ΔQ). More specifically, the fluid amount characteristic (the fluid amount characteristic value ΔQ) when the wheel cylinder pressure control unit 44 has been started up last time, such as the latest fluid amount characteristic (the fluid amount characteristic value ΔQ) calculated last when the wheel cylinder pressure control unit 44 has been in operation last time, is stored in the memory 44G, which is the EEPROM (the nonvolatile memory). Due to this storage, the wheel cylinder pressure control unit 44 can perform the control with use of the fluid amount characteristic (the fluid amount characteristic value ΔQ) stored in the nonvolatile memory (the memory 44G), i.e., the latest fluid amount characteristic (the fluid amount characteristic value ΔQ and thus the corrected fluid amount-hydraulic pressure characteristic map 62), immediately since just after being started up. The fluid amount characteristic (the fluid amount characteristic value ΔQ) may be stored in the memory 44G on the wheel cylinder pressure control unit 44 side, may be stored in the memory 25D on the master cylinder pressure control unit 25 side, or may be stored in both the memories 44G and 25D.

In the above description, the fluid amount-hydraulic pressure characteristic map 61 (FIG. 7) is corrected for the correction of the target fluid amount based on the fluid amount characteristic value ΔQ. However, the correction of the target fluid amount is not limited thereto, and may be carried out by, for example, directly adding the fluid amount characteristic value ΔQ to the target fluid amount calculated from the fluid amount-hydraulic pressure characteristic map 61 before the correction.

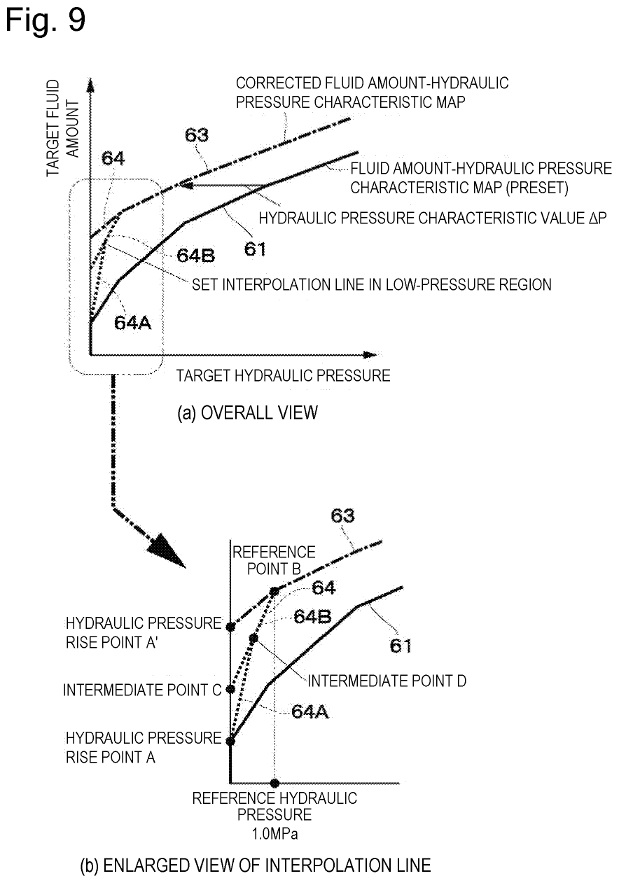

Further, in the above description, the fluid amount-hydraulic pressure characteristic map 61 (FIG. 7) is corrected after the hydraulic pressure characteristic value ΔP is converted into the fluid amount characteristic value ΔQ. However, the correction of the fluid amount-hydraulic pressure characteristic map 61 is not limited thereto, and, for example, the fluid amount-hydraulic pressure characteristic map 61 may be corrected in a direction of a hydraulic pressure axis with use of the hydraulic pressure characteristic value ΔP as illustrated in FIG. 9. In other words, the fluid amount-hydraulic pressure characteristic map 61 may be corrected into a corrected fluid amount-hydraulic pressure characteristic map 63 with use of the hydraulic pressure characteristic value ΔP. In this case, for example, the master cylinder pressure control unit 25 can be configured to transmit the hydraulic pressure characteristic value ΔP to the wheel cylinder pressure control unit 44, and the wheel cylinder pressure control unit 44 can be configured to correct the fluid amount-hydraulic pressure characteristic map 61 with use of the hydraulic pressure characteristic value ΔP transmitted from the master cylinder pressure control unit 25. However, in this case, simply just correcting the map results in generation of a map that exhibits an increase in an invalid fluid amount until the hydraulic pressure rises, and then has a sudden pressure increase when the fluid amount is just slightly changed after the hydraulic pressure rises (the corrected fluid amount-hydraulic pressure characteristic map 63). Therefore, the control accuracy may be deteriorated in a region where the target hydraulic pressure is low.

Therefore, it is desirable to, for example, interpolate the characteristic in the low-pressure region lost due to the offset of the fluid amount-hydraulic pressure characteristic map 61 along the hydraulic pressure axis as illustrated in an overall view of FIG. 9(a). More specifically, it is desirable to generate an interpolation line 64 that smooths the connection of the fluid amount-hydraulic pressure characteristic in the low-pressure region so as to eliminate the sudden change after the hydraulic pressure rises, thereby preventing or reducing the deterioration of the control accuracy. As the interpolation line 64, for example, a point A, a point A′, a reference point B, a point C, and a point D are set at a point where the hydraulic pressure rises in the preset fluid amount-hydraulic pressure characteristic map 61, a point where the hydraulic pressure rises in the corrected fluid amount-hydraulic pressure characteristic map 63 corrected based on the hydraulic pressure characteristic value ΔP, an intersection point between a reference hydraulic pressure 1.0 MPa and the corrected fluid amount-hydraulic pressure characteristic map 63, an intermediate point between the point A and the point A′, and an intermediate point of a line segment formed by the reference point B and the intermediate point C, respectively, as illustrated in an enlarged view of FIG. 9(b). In this case, a line segment 64A and a line segment 64B are formed between the hydraulic-pressure rise point A and the intermediate point D and between the intermediate point D and the reference point B, respectively, and they are defined to be the interpolation line 64. Then, in the low-pressure region where the target hydraulic pressure is equal to or lower than the reference hydraulic pressure 1.0 MPa, the target fluid amount is calculated with use of the above-described interpolation line (the line segment 64A and the line segment 64B) instead of the corrected fluid amount-hydraulic pressure characteristic map 63.

In this manner, according to the first embodiment, the wheel cylinder pressure control unit 44 controls the wheel cylinder pressure control mechanism 31 based on the fluid amount characteristic (the corrected fluid amount-hydraulic pressure characteristic map 62 corrected based on the fluid amount characteristic value ΔQ, or the corrected fluid amount-hydraulic pressure characteristic map 63 corrected based on the hydraulic pressure characteristic value ΔP and the interpolation line 64), which is the characteristic of the fluid amount with respect to the value detected by the master cylinder pressure sensor 43A. Therefore, even when the fluid amount-hydraulic pressure characteristic is changed according to the change in the caliper or the rotor, the pipe layout, the outside temperature, the fluid temperature, the empirical pressure, or the like, the wheel cylinder pressure control unit 44 can control the wheel cylinder pressure control mechanism 31 in consideration of this change. As a result, the brake system 1 can improve the accuracy of controlling the wheel cylinder pressure using the wheel cylinder pressure control mechanism 31. In this case, correcting the discharge fluid amount (the target fluid amount) based on the fluid amount characteristic value ΔQ allows the brake system 1 to secure the accuracy of calculating the estimated hydraulic pressure in a region corresponding to regular use of the hydraulic pressure (for example, the hydraulic-pressure region equal to or lower than 1.0 MPa).

In addition, an originally mounted sensor can be used as the master cylinder pressure sensor 43A. Therefore, the brake system 1 can improve the accuracy of controlling the wheel cylinder pressure without additionally including a hydraulic pressure (for example, a wheel cylinder pressure sensor) separately from it. As a result, the brake system 1 can achieve redundancy of the electric brake system including the automatic brake in addition to preventing or cutting down a cost increase.

According to the first embodiment, the master cylinder pressure control unit 25 calculates the fluid amount characteristic value ΔQ (or the hydraulic pressure characteristic value ΔP). Therefore, the brake system 1 can calculate the fluid amount characteristic value ΔQ (or the hydraulic pressure characteristic value ΔP) in the normal brake operation even without actuating the wheel cylinder pressure control mechanism 31, which is the ESC (the fluid amount supply device).

According to the first embodiment, the wheel cylinder pressure control unit 44 controls the wheel cylinder pressure control mechanism 31 based on the fluid amount characteristic value ΔQ (the corrected fluid amount-hydraulic pressure characteristic map 62 corrected based thereon) or the hydraulic pressure characteristic value ΔP (the corrected fluid amount-hydraulic pressure characteristic map 63 corrected based thereon and the interpolation line 64) transmitted from the master cylinder pressure control unit 25 when the hydraulic pressure corresponding to the braking instruction (the autonomous brake instruction or the pedal operation amount) cannot be generated with use of the electric motor 16 of the electric booster 10. Therefore, the wheel cylinder pressure control unit 44 can control the wheel cylinder pressure control mechanism 31 in consideration of the change in the fluid amount-hydraulic pressure characteristic even when a failure has occurred in the electric motor 16, the ball screw mechanism 19, the belt speed reduction mechanism 23, the master cylinder pressure control unit 25, or the like of the electric booster 10. As a result, the brake system 1 can accurately perform the backup control using the wheel cylinder pressure control mechanism 31, i.e., the control of the wheel cylinder pressure using the wheel cylinder pressure control mechanism 31.

The wheel cylinder pressure control unit 44 can control the wheel cylinder pressure control mechanism 31 in consideration of the change in the fluid amount-hydraulic pressure characteristic not only when the hydraulic pressure cannot be generated with use of the electric booster 10 but also when the hydraulic pressure can be generated with use of the electric booster 10. For example, the fluid amount characteristic value ΔQ (the corrected fluid amount-hydraulic pressure characteristic map 62 corrected based thereon) or the hydraulic pressure characteristic value ΔP (the corrected fluid amount-hydraulic pressure characteristic map 63 corrected based thereon and the interpolation line 64) may be used for the pressure increase control by the wheel cylinder pressure control unit 44, such as the vehicle stabilization control including the sideslip prevention and the traction control performed by the wheel cylinder pressure control mechanism 31. In this case, the brake system 1 can improve the accuracy of controlling the wheel cylinder pressure by the driving of the wheel cylinder pressure control mechanism 31 regardless of whether the electric booster 10 is normal or has broken down.

According to the first embodiment, the wheel cylinder pressure control unit 44 can use the fluid amount characteristic stored in the nonvolatile memory (the memory 44G) (the fluid amount characteristic value ΔQ or the hydraulic pressure characteristic value ΔP) since immediately after being started up. Therefore, the brake system 1 can accurately perform the backup control using the wheel cylinder pressure control mechanism 31 even when a failure has occurred in the electric booster 10 since immediately after the startup.

Any of the memories 25D and 44G of the master cylinder pressure control unit 25 and the wheel cylinder pressure control unit 44 may be used as the storage circuit that stores therein the fluid amount characteristic value ΔQ (or the hydraulic pressure characteristic value ΔP) according to the first embodiment. However, for example, when a failure has occurred in the master cylinder pressure control unit 25 or when the communication becomes impossible between the master cylinder pressure control unit 25 and the wheel cylinder pressure control unit 44 as the system, the wheel cylinder pressure control unit 44 may be unable to receive the fluid amount characteristic value ΔQ (or the hydraulic pressure characteristic value ΔP). Therefore, it is desirable to store the fluid amount characteristic value ΔQ (or the hydraulic pressure characteristic value ΔP) in the storage circuit of the wheel cylinder pressure control unit 44 (the memory 44G).

Further, in the first embodiment, the brake system 1 has been described as being configured in such a manner that the master cylinder pressure control unit 25 calculates the fluid amount characteristic value ΔQ (or the hydraulic pressure characteristic value ΔP) by way of example. However, the brake system 1 is not limited thereto, and, for example, may be configured to cause the wheel cylinder pressure control unit 44 to calculate the fluid amount characteristic value ΔQ and thus the corrected fluid amount-hydraulic pressure characteristic map 62 (or the hydraulic pressure characteristic value ΔP and thus the corrected fluid amount-hydraulic pressure characteristic map 63 and the interpolation line 64) by inputting a “signal for calculating the fluid amount such as the pedal operation amount, or the fluid amount” and the “master cylinder pressure” to the wheel cylinder pressure control unit 44. Configuring the brake system 1 in this manner allows the wheel cylinder pressure control unit 44 to perform independent correction processing without being affected by the master cylinder pressure control unit 25.

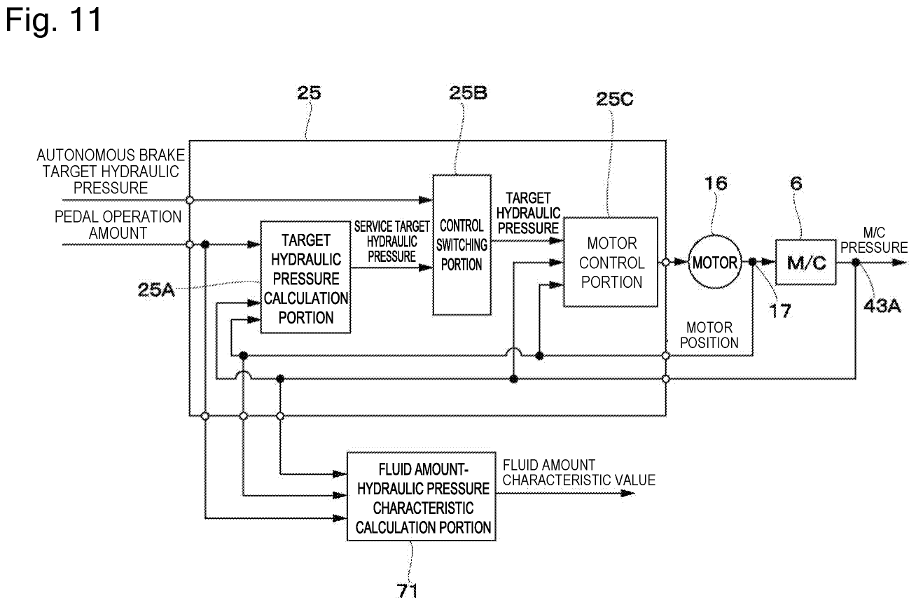

Next, FIGS. 11 to 15 illustrate a second embodiment. The second embodiment is characterized by being configured to include a fluid amount-hydraulic pressure characteristic calculation portion that calculates the fluid amount-hydraulic pressure characteristic separately from the hydraulic pressure control circuit. The second embodiment will be described, indicating similar components to the first embodiment by the same reference numerals and omitting the descriptions thereof.

In the above-described first embodiment, the target fluid amount calculation portion 44A of the wheel cylinder pressure control unit 44 corrects the target fluid amount based on the fluid amount characteristic value ΔQ calculated from the hydraulic pressure characteristic value ΔP already calculated by the master cylinder pressure control unit 25 (the target hydraulic pressure calculation portion 25A). On the other hand, the second embodiment includes a fluid amount-hydraulic pressure characteristic calculation portion 71 that calculates the fluid amount characteristic value ΔQ separately from the target hydraulic pressure calculation portion 25A of the master cylinder pressure control unit 25 as illustrated in FIG. 11. The fluid amount-hydraulic pressure characteristic calculation portion 71 can be configured to be included in, for example, the master cylinder pressure control unit 25, the wheel cylinder pressure control unit 44, or another ECU different from these units 25 and 44 (for example, in the vehicle ECU 46 or an ECU specifically prepared for the calculation of the fluid amount characteristic value ΔQ).

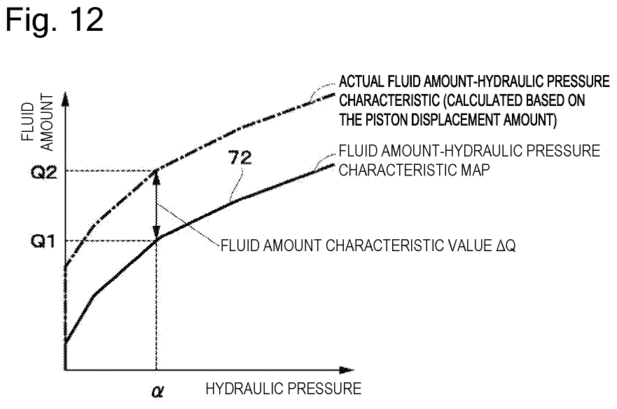

In the second embodiment, the fluid amount-hydraulic pressure characteristic calculation portion 71 receives the master cylinder pressure (a) detected by the master cylinder pressure sensor 43A and calculates a difference between a fluid amount Q2 and a fluid amount Q1 as the fluid amount characteristic value ΔQ, as illustrated in FIG. 12. The fluid amount Q2 is an actual fluid amount calculated based on the values detected by the brake operation amount detector 24 and the rotational angle detection sensor 17 that correspond to the displacement amounts of the input rod 13 and the primary piston 6A when the master cylinder pressure is a. The fluid amount Q1 is a fluid amount calculated with use of a preset nominal fluid amount-hydraulic pressure characteristic map 72 when the master cylinder pressure is a. The fluid amount characteristic value ΔQ calculated by the fluid amount-hydraulic pressure characteristic calculation portion 71 (=the fluid amount Q2−the fluid amount Q1) is transmitted (output) to the wheel cylinder pressure control unit 44. The target fluid amount calculation portion 44A of the wheel cylinder pressure control unit 44 calculates the target hydraulic pressure based on the corrected fluid amount-hydraulic pressure characteristic map 62 corrected based on the fluid amount characteristic value ΔQ (converts the target hydraulic pressure into the target fluid amount) similarly to the above-described first embodiment.

Next, specific processing for calculating the fluid amount characteristic value ΔQ by the fluid amount-hydraulic pressure characteristic calculation portion 71 will be described.

FIGS. 13 to 15 illustrate processing flows performed by the fluid amount-hydraulic pressure characteristic calculation portion 71. The processing flow illustrated in FIG. 13 is performed (started) every time the input rod 13 or the primary piston 6A operates according to the braking instruction derived from the brake pedal operation or the autonomous brake to calculate the fluid amount characteristic value ΔQ.

When the processing flow illustrated in FIG. 13 is started, in S1, the fluid amount-hydraulic pressure characteristic calculation portion 71 reads in a previously employed fluid amount characteristic value (a stored fluid amount characteristic value) stored in the storage circuit (for example, a memory of the fluid amount-hydraulic pressure characteristic calculation portion 71). For example, an employed fluid amount characteristic value employed by the fluid amount-hydraulic pressure characteristic calculation portion 71 at the time of the last boosting operation is stored in the storage circuit and used as this stored fluid amount characteristic value. Alternatively, an employed fluid amount characteristic value used last when the master cylinder pressure control unit 25 has been started up last time is stored in the storage circuit and used as the stored fluid amount characteristic value.

In the subsequent step, S2, the fluid amount-hydraulic pressure characteristic calculation portion 71 determines whether or not the fluid amount characteristic value has ever been calculated since the startup of the master cylinder pressure control unit 25. If “NO” is determined in S2, i.e., the actual fluid amount-hydraulic pressure characteristic has never been recognized since the startup of the master cylinder pressure control unit 25, the flow proceeds to S3. In S3, the fluid amount-hydraulic pressure characteristic calculation portion 71 calculates the fluid amount characteristic value. At this time, if the boosting operation is ended during the processing of S3, i.e., during the calculation of the fluid amount characteristic value, the processing subsequent thereto is not performed.

After the calculation of the fluid amount characteristic value is completed in S3, the flow proceeds to S4. In S4, the fluid amount-hydraulic pressure characteristic calculation portion 71 calculates a difference between the calculated fluid amount characteristic value calculated in S3 and the employed fluid amount characteristic value read in from the storage circuit in S1, and determines whether this difference falls within a predetermined value or not. This processing is performed to calculate the fluid amount characteristic value without being affected by the previous employed fluid amount characteristic value when the fluid amount-hydraulic pressure characteristic is largely changed due to, for example, the replacement of the caliper or an air removal.

If “YES” is determined in S4, the flow proceeds to S5. In S5, the fluid amount-hydraulic pressure characteristic calculation portion 71 determines that the fluid amount characteristic value has been already calculated by the fluid amount-hydraulic pressure characteristic calculation portion 71 after the startup of the master cylinder pressure control unit 25. As a result, in the processing of step S2 after the next step, i.e., when the flow proceeds to S2 next time, “YES” is yielded as the determination. In S6 subsequent to S5, the fluid amount-hydraulic pressure characteristic calculation portion 71 compares the calculated fluid amount characteristic value and the employed fluid amount characteristic value, and selects the larger one of them as a new employed fluid amount characteristic value. The characteristic that leads to an increase in the brake characteristic after the correction is employed to prevent an extreme reduction in the braking force due to underestimation of the target fluid amount required to realize the target wheel cylinder pressure when the mechanism realizing the braking such as the autonomous braking is switched from the master pressure control mechanism 11 to the wheel cylinder pressure control mechanism 31. However, such a value that the brake characteristic reduces may be selected to prevent the braking force from increasing more than the intention, and the selection method is not limited. After the maximum value is employed in S6, the flow returns to START via END.

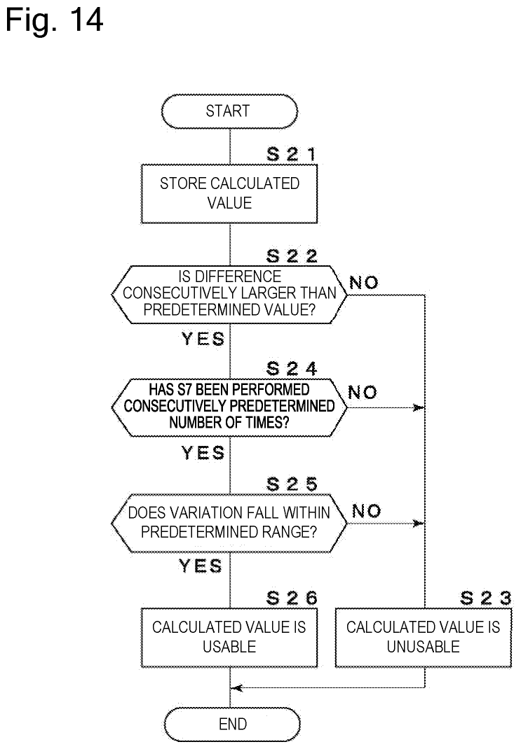

If “NO” is determined in S4, the flow proceeds to processing performed when the difference is large in S7. The processing performed when the difference is large in S7 is processing for determining whether the calculated fluid amount characteristic value calculated in S3 can be used or not. The processing performed when the difference is large in S7 will be described with reference to FIG. 14. FIG. 14 is a control flow of the processing performed when the difference is large in S7.

In S21 illustrated in FIG. 14, the fluid amount-hydraulic pressure characteristic calculation portion 71 stores the calculated fluid amount characteristic value calculated in S3 into the storage circuit. The stored value stored in S21 is different from the stored value read in S1, and previous values as many as the predetermined number of times are stored in S21. In S22 subsequent to S21, the fluid amount-hydraulic pressure characteristic calculation portion 71 determines whether or not the difference is continuously determined to be equal to or larger than the predetermined value in S4, i.e., whether or not the processing of S7 has also been performed when the boosting operation has been performed last time. If “NO” is determined in S22, the flow proceeds to S23 because the reliability of the calculated value cannot be determined yet. In S23, the fluid amount-hydraulic pressure characteristic calculation portion 71 determines that the calculated hydraulic pressure characteristic value calculated in S3 cannot be used, i.e., the calculated value is unusable. After the calculated value is determined to be unusable in S23, the flow proceeds to S8 illustrated in FIG. 13 via END.

On the other hand, if “YES” is determined in S22, the flow proceeds to S24. In S24, the fluid amount-hydraulic pressure characteristic calculation portion 71 determines whether the processing of S7 has been consecutively performed the predetermined number of times or not. If “NO” is determined in S24, the flow proceeds to S23 because the reliability of the calculated value cannot be determined yet similarly to when “NO” is determined in S22. In other words, the fluid amount-hydraulic pressure characteristic calculation portion 71 determines that the calculated fluid amount characteristic value calculated in S3 cannot be used (the calculated value is unusable) in S23, and the flow proceeds to S8 illustrated in FIG. 13 via END.

If “YES” is determined in S24, the flow proceeds to S25. In S25, the fluid amount-hydraulic pressure characteristic calculation portion 71 determines whether or not a variation in the previous calculated fluid amount characteristic values as many as the predetermined number of times that have been stored in S21 falls within a predetermined range. If “YES” is determined in S25, i.e., the variation in the previous calculated fluid amount characteristic values as many as the predetermined number of times is determined to fall within the predetermined range, the fluid amount-hydraulic pressure characteristic calculation portion 71 can determine that the calculated fluid amount characteristic value calculated in S3 is correctly calculated. In this case, the flow proceeds to S26, and the fluid amount-hydraulic pressure characteristic calculation portion 71 determines that the calculated fluid amount characteristic value calculated in S3 can be used. After the calculated value is determined to be usable in S26, the flow proceeds to S8 illustrated in FIG. 13 via END.

On the other hand, if “NO” is determined in S25, i.e., the variation in the previous calculated fluid amount characteristic values as many as the predetermined number of times is determined to fall outside the predetermined range, the fluid amount-hydraulic pressure characteristic calculation portion 71 can determine that the calculated fluid amount characteristic value calculated in S3 is not correctly calculated. In this case, the flow proceeds to S23, and the fluid amount-hydraulic pressure characteristic calculation portion 71 determines that the calculated fluid amount characteristic value calculated in S3 cannot be used (the calculated value is unusable). Then, the flow proceeds to S8 illustrated in FIG. 13 via END.

In S8 illustrated in FIG. 13, the fluid amount-hydraulic pressure characteristic calculation portion 71 determines whether the calculated fluid amount characteristic value calculated in S3 can be used based on the result of the determination from the processing performed when the difference is large in S7. If “YES” is determined in S8, i.e., the calculated fluid amount characteristic value calculated in S3 is determined to be able to be used, the flow proceeds to S9. In S9, the fluid amount-hydraulic pressure characteristic calculation portion 71 sets the value calculated in S3 as a new employed fluid amount characteristic value. Then, the flow returns to START via END.

On the other hand, if “NO” is determined in S8, i.e., the calculated fluid amount characteristic value calculated in S3 is determined to be unable to be used, the flow proceeds to S11. In S11, the fluid amount-hydraulic pressure characteristic calculation portion 71 directly sets the stored value read in S1 as the employed fluid amount characteristic value, and the flow returns to START via END.

Next, if “YES” is determined in S2, i.e., the calculation of the fluid amount characteristic value is determined to have been performed, the flow proceeds to S10. In S10, the fluid amount-hydraulic pressure characteristic calculation portion 71 determines whether or not the fluid amount-hydraulic pressure characteristic is changed since when the fluid amount characteristic value has been calculated last time.

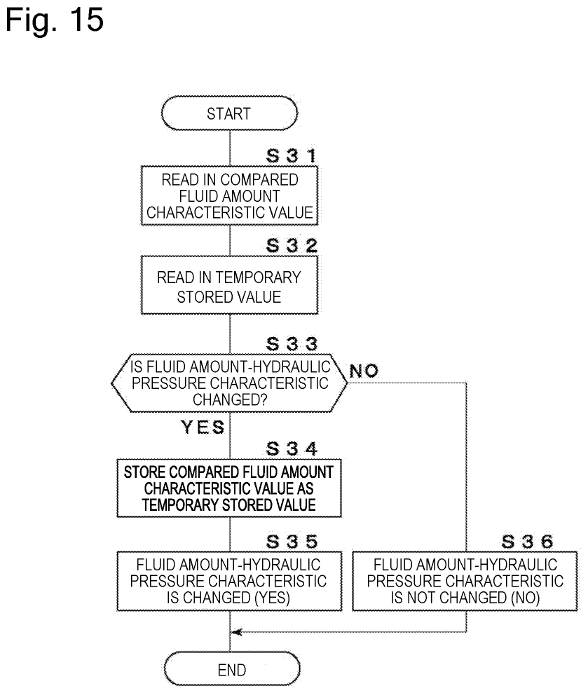

The determination processing in S10 will be described with reference to FIG. 15. FIG. 15 illustrates a control flow of the processing for determining whether the fluid amount-hydraulic pressure characteristic is changed or not in S10.

In S31 illustrated in FIG. 15, the fluid amount-hydraulic pressure characteristic calculation portion 71 reads in a compared fluid amount characteristic value. Now, for example, a fluid amount transmitted out of the master cylinder 6 and a generated brake hydraulic pressure at the time of the last boosting operation are used as the compared fluid amount characteristic value. Alternatively, the compared fluid amount characteristic value may be set by actuating the electric motor 16 to generate a hydraulic pressure independently of the operation on the brake pedal 9 while the vehicle is stopped, and acquiring the characteristic between a fluid amount transmitted out of the master cylinder 6 and a generated brake hydraulic pressure.

In S32 subsequent to S31, the fluid amount-hydraulic pressure characteristic calculation portion 71 reads in a temporary stored value stored in the storage circuit in processing that will be described below. In S33 subsequent to S32, the fluid amount-hydraulic pressure characteristic calculation portion 71 compares the compared fluid amount characteristic value read in S31 and the temporary stored value read in S32, and determines whether the fluid amount-hydraulic pressure characteristic is changed or not. At this time, the fluid amount-hydraulic pressure characteristic calculation portion 71 uses, for example, exceedance of the difference between the hydraulic pressure generated when the predetermined fluid amount is transmitted out of the master cylinder 6 and the hydraulic pressure calculated with use of the corrected fluid amount-hydraulic pressure characteristic map with the predetermined fluid amount set as the input over a predetermined value, as a condition for determining that the fluid amount-hydraulic pressure characteristic is changed.

If “YES” is determined in S33, i.e., the fluid amount-hydraulic pressure characteristic is determined to be changed, the flow proceeds to S34. In S34, the fluid amount-hydraulic pressure characteristic calculation portion 71 stores the compared fluid amount characteristic value read in S31 into the storage circuit as the temporary stored value. This temporary stored value stored in S34 is read in S32. Then, the fluid amount-hydraulic pressure characteristic is determined to be changed in S35, and the flow proceeds to END. In this case, “YES” is determined as the result of the determination in S10 illustrated in FIG. 13, and the flow proceeds from S10 to S3.

On the other hand, if “NO” is determined in S33, i.e., the fluid amount-hydraulic pressure characteristic is determined not to be changed, the fluid amount-hydraulic pressure characteristic calculation portion 71 determines no change in the fluid amount-hydraulic pressure characteristic in S36, and the flow proceeds to END. In this case, “NO” is determined as the result of the determination in S10 illustrated in FIG. 13, and the flow proceeds from S10 to S11.

Now, the processing of S34 is not performed (the compared fluid amount characteristic value is not stored as the temporary stored value) until “YES” is determined in S33, and, therefore, for example, a fluid amount characteristic value serving as a reference is used as an initial value. Alternatively, the fluid amount-hydraulic pressure characteristic calculation portion 71 may use the compared fluid amount characteristic value read in S31 as the temporary stored value if the stored fluid amount characteristic value is not stored when the processing of S32 is performed, and store it into the storage circuit after the processing of S10 is ended.

If “NO” is determined in S10, the flow proceeds to S11. In S11, the fluid amount-hydraulic pressure characteristic calculation portion 71 employs the employed fluid amount characteristic value used at the time of the last boosting operation, and the flow returns to START via END. If “YES” is determined in S10, the same processing as when “NO” is determined in S2 is performed. As a result, the fluid amount characteristic value is recalculated when the fluid amount-hydraulic pressure characteristic is changed since after the startup of the master cylinder pressure control unit 25. Further, when the fluid amount required to realize the target hydraulic pressure cannot be generated at the time of the next boosting operation, the fluid amount-hydraulic pressure characteristic calculation portion 71 determines “NO” in S2 at the time of the next boosting operation assuming that the calculation of the fluid amount characteristic value has not been performed yet, and calculates the fluid amount characteristic value in S3.

The second embodiment is configured to calculate the fluid amount characteristic value ΔQ according to the control flows illustrated in FIGS. 13 to 15 in the above-described manner, and the basic advantageous effects thereof are not especially different from those according to the first embodiment. More specifically, in the second embodiment, the wheel cylinder pressure control unit 44 also controls the wheel cylinder pressure control mechanism 31 based on the fluid amount characteristic (i.e., the corrected fluid amount-hydraulic pressure characteristic map 62 corrected based on the fluid amount characteristic value ΔQ), which is the characteristic of the fluid amount with respect to the value detected by the master cylinder pressure sensor 43A, similarly to the first embodiment. As a result, the brake system can improve the accuracy of controlling the wheel cylinder pressure using the wheel cylinder pressure control mechanism 31.

In the second embodiment, the brake system is configured to calculate the fluid amount characteristic value when the boosting operation is performed for the first time after the master cylinder pressure control unit 25 is started up, by determining whether the fluid amount characteristic value has been already calculated after the startup of the master cylinder pressure control unit 25 in S1. However, the brake system is not limited thereto, and may be configured to calculate the fluid amount characteristic value only when the fluid amount-hydraulic pressure characteristic is changed by, for example, being configured not to perform the processing of S1 but perform the processing of S10 subsequently to S1. Alternatively, the brake system may be configured to calculate the fluid amount characteristic value by carrying out calibration (correction), for example, at the time of the shipment from the factory.

Further, in the above-described first and second embodiments, the brake system is configured to correct the target fluid amount to improve the control accuracy when performing the boosting by the wheel cylinder pressure control unit 44 or when realizing the autonomous brake, in the case where a failure has occurred in the master cylinder pressure control unit 25. However, the brake system is not limited thereto, and, for example, may be configured to use the fluid amount-hydraulic pressure characteristic (the corrected fluid amount-hydraulic pressure characteristic map 62, or the corrected fluid amount-hydraulic pressure characteristic map 63 and the interpolation line 64) when driving the wheel cylinder pressure control mechanism 31 by the wheel cylinder pressure control unit 44 regardless of whether the master cylinder pressure control unit 25 is normal or not. In other words, the brake system may be configured to use the hydraulic pressure characteristic value ΔP (thus the corrected fluid amount-hydraulic pressure characteristic map 63 and the interpolation line 64) or the fluid amount characteristic value ΔQ (thus the corrected fluid amount-hydraulic pressure characteristic map 62) described in the first embodiment and the second embodiment for the pressure increase control by the wheel cylinder pressure control unit 44, such as the vehicle stabilization control including the sideslip prevention and the traction control. Configuring the brake system in this manner allows accurate posture control to be realized not only during the backup control but also during the normal pressure increase control.

In the above-described first and second embodiments, the master cylinder pressure detected by the master cylinder pressure sensor 43A is used to calculate the estimated fluid amount in consideration of the fluid amount discharged by the master cylinder 6. However, when a failure has occurred in the master cylinder pressure sensor 43A, this makes it impossible to calculate the fluid amount discharged by the master cylinder 6, thereby leading to a reduction in the accuracy of controlling the hydraulic pressure. Therefore, when determining that a failure has occurred in the master cylinder pressure sensor 43A, the brake system calculates an estimated master cylinder pressure based on the fluid amount-hydraulic pressure characteristic map corrected by the above-described embodiments while receiving, as an input, the discharge fluid amount of the master cylinder 6 that is calculated with use of the values detected by the brake operation amount detector 24 and the rotational angle detection sensor 17 that correspond to the displacement amounts of the input rod 13 and the primary piston 6A.

Then, the brake system can realize the wheel cylinder pressure control without use of the master cylinder pressure sensor 43A by calculating the fluid amount discharged by the master cylinder 6 with use of the calculated estimated master cylinder pressure. More specifically, the present configuration allows the brake system to perform the hydraulic pressure control without use of the master cylinder pressure sensor 43A by using the discharge fluid amount of the master cylinder 6 that is calculated by the above-described method as the master cylinder discharge fluid amount in the control block diagram of the wheel cylinder pressure control unit 44 illustrated in FIG. 4, when a failure has occurred in the master cylinder pressure sensor 43A. The brake system may directly use the discharge fluid amount of the master cylinder 6 that is calculated with use of the values detected by the brake operation amount detector 24 and the rotational angle detection sensor 17 that correspond to the displacement amounts of the input rod 13 and the primary piston 6A as the master discharge fluid amount in the control block illustrated in FIG. 4, instead of calculating the estimated master cylinder pressure. In this manner, the present configuration allows the brake system to estimate the hydraulic pressure based on the fluid amount, thereby allowing the brake system to perform the hydraulic pressure control without use of the master cylinder pressure sensor 43A, even when a failure (a malfunction) has occurred in the master cylinder pressure sensor 43A.

In the above-described first and second embodiments, the brake system has been described as being configured to connect the master cylinder pressure sensor 43A to the wheel cylinder pressure control unit 44 by way of example. However, the brake system is not limited thereto, and, for example, may be configured to connect the master cylinder pressure sensor 43A to the master cylinder pressure control unit 25. More specifically, the brake system may connect the master cylinder pressure sensor 43A to the wheel cylinder pressure control unit 44 and calculate the fluid amount characteristic value ΔQ (or the hydraulic pressure characteristic value ΔP) by the master cylinder pressure control unit 25 or the wheel cylinder pressure control unit 44, or may connect the master cylinder pressure sensor 43A to the master cylinder pressure control unit 25 and calculate the fluid amount characteristic value ΔQ (or the hydraulic pressure characteristic value ΔP) by the master cylinder pressure control unit 25 or the wheel cylinder pressure control unit 44. Further, the master cylinder pressure sensor 43A has been described as being configured to detect the hydraulic pressure at the primary port 6F of the master cylinder 6, but may be configured to detect the hydraulic pressure at the secondary port 6G. Further, the brake system is configured to include one master cylinder pressure sensor 43A, but, for example, may be configured to include a plurality of (two) master cylinder pressure sensors 43A and detect, for example, both the hydraulic pressure at the primary port 6F and the hydraulic pressure at the secondary port 6G.

In the above-described embodiments, the brake system has been described as being configured to not only generate the deceleration on the vehicle by driving the electric motor 16 according to the braking instruction (a braking request) derived from the operation on the brake pedal 9 but also generate the deceleration on the vehicle by driving the electric motor 16 according to the braking instruction (a braking request) derived from the autonomous brake instruction, by way of example. However, the brake system is not limited thereto, and, for example, may be configured to generate the deceleration on the vehicle according to any one of them (for example, configured to omit the autonomous brake function).

In the above-described embodiments, the electric actuator has been described assuming that the rotational motor is used as the electric motor 16 corresponding to the electric actuator by way of example. However, the electric actuator is not limited thereto, and, for example, a linearly movable motor (a linear motor) may be used as the electric actuator. In other words, various kinds of electric actuators can be used as the electric actuator that thrusts forward the piston of the electric booster 10 (the master pressure control mechanism 11) (i.e., the primary piston 6A of the master cylinder 6). Further, each of the embodiments is only an example, and it is apparent that the configurations indicated in the different embodiments can be partially replaced or combined.

Possible configurations as the electric brake system, the hydraulic pressure control circuit, and the fluid amount control circuit based on the above-described embodiments include the following examples.

(1) As a first configuration, an electric brake system includes a hydraulic pressure control circuit configured to acquire a detected value from a hydraulic pressure detection portion configured to detect a hydraulic pressure in a master cylinder and control driving of an electric actuator in such a manner that a target hydraulic pressure corresponding to a braking instruction is generated in the master cylinder, a fluid amount control circuit configured to drive a fluid amount supply device disposed between the master cylinder and a wheel cylinder to control a fluid amount to supply to the wheel cylinder, and a storage circuit configured to store a fluid amount characteristic, which is a characteristic of the fluid amount with respect to the detected value. The fluid amount control circuit controls the fluid amount supply device based on the fluid amount characteristic stored in the storage circuit.

According to this first configuration, the fluid amount control circuit controls the fluid amount supply device based on the fluid amount characteristic, which is the characteristic of the fluid amount with respect to the detected value from the hydraulic pressure detection portion. Therefore, even when the fluid amount-hydraulic pressure characteristic is changed according to the change in the caliper, the rotor, the pipe layout, the outside temperature, the fluid temperature, the empirical pressure, or the like, the fluid amount control circuit can control the fluid amount supply device in consideration of this change. As a result, the electric brake system can improve the accuracy of controlling the wheel cylinder pressure using the fluid amount supply device. In this case, the electric brake system can improve the accuracy of controlling the wheel cylinder pressure using the fluid amount supply device regardless of whether the electric actuator or the hydraulic pressure control circuit is normal or has broken down, by controlling the fluid amount supply device in consideration of the change in the fluid amount-hydraulic pressure characteristic not only when the hydraulic pressure corresponding to the braking instruction cannot be generated with use of the electric actuator but also when the hydraulic pressure can be generated. In addition, an originally mounted sensor can be used as the hydraulic pressure detection portion. Therefore, the electric brake system can improve the accuracy of controlling the wheel cylinder pressure without additionally including a hydraulic pressure sensor (for example, a wheel cylinder pressure sensor) separately from it. As a result, the electric brake system can achieve redundancy of the electric brake system including the automatic brake in addition to preventing or cutting down a cost increase.

(2) As a second configuration, in the first configuration, the fluid amount control circuit controls the fluid amount supply device based on the fluid amount characteristic when the target hydraulic pressure corresponding to the braking instruction cannot be generated with use of the electric actuator.

According to this second configuration, the fluid amount control circuit can control the fluid amount supply device in consideration of the change in the fluid amount-hydraulic pressure characteristic when the hydraulic pressure corresponding to the braking instruction cannot be generated with use of the electric actuator. As a result, the electric brake system can accurately perform the backup control using the fluid amount supply device, i.e., the control of the wheel cylinder pressure using the fluid amount supply device even when a failure has occurred in the electric actuator or the hydraulic pressure control circuit.

(3) As a third configuration, in the second configuration, the hydraulic pressure control circuit transmits the fluid amount characteristic to the fluid amount control circuit when the target hydraulic pressure corresponding to the braking instruction cannot be generated with use of the electric actuator.

According to this third configuration, the fluid amount control circuit controls the fluid amount supply device based on the fluid amount characteristic transmitted from the hydraulic pressure control circuit when the hydraulic pressure corresponding to the braking instruction cannot be generated with use of the electric actuator. Therefore, the electric brake system can control the fluid amount supply device in consideration of the change in the fluid amount-hydraulic pressure characteristic even when a failure has occurred in the electric actuator or the hydraulic pressure control circuit, thereby being able to accurately perform the backup control using the fluid amount supply device.

(4) As a fourth configuration, in any of the first to third configurations, the fluid amount characteristic at the time of a last startup is stored in a nonvolatile memory. According to this fourth configuration, the fluid amount control circuit can control the fluid amount supply device based on the fluid amount characteristic at the time of the last startup that is stored in the nonvolatile memory since immediately after the startup. Therefore, the electric brake system can control the fluid amount supply device in consideration of the change in the fluid amount-hydraulic pressure characteristic even when a failure has occurred in the electric actuator or the hydraulic pressure control circuit since immediately after the startup, thereby being able to accurately perform the backup control using the fluid amount supply device.

(5) As a fifth configuration, in the first configuration, the fluid amount characteristic is stored in the storage circuit on a hydraulic pressure control circuit side. According to this fifth configuration, the fluid amount control circuit can accurately control the wheel cylinder pressure using the fluid amount supply device based on the fluid amount characteristic stored in the storage circuit on the hydraulic pressure control circuit side.

(6) As a sixth configuration, in the first configuration, the fluid amount characteristic is stored in the storage circuit on a fluid amount control circuit side. According to this sixth configuration, the fluid amount control circuit can accurately control the wheel cylinder pressure using the fluid amount supply device based on the fluid amount characteristic stored in the storage circuit on the fluid amount control circuit side.

(7) A seventh configuration is a hydraulic pressure control circuit. The hydraulic pressure control circuit is configured to acquire a detected value from a hydraulic pressure detection portion configured to detect a hydraulic pressure in a master cylinder, and control driving of an electric actuator in such a manner that a target hydraulic pressure corresponding to a braking instruction is generated in the master cylinder. The hydraulic pressure control circuit transmits a fluid amount characteristic to a fluid amount control circuit. The fluid amount control circuit is configured to drive a fluid amount supply device. The fluid amount supply device is disposed between the master cylinder and a wheel cylinder. The fluid amount control circuit is configured to store the fluid amount characteristic, which is a characteristic of a fluid amount with respect to the detected value.

According to this seventh configuration, the fluid amount control circuit can control the fluid amount supply device based on the fluid amount characteristic transmitted from the hydraulic pressure control circuit. In this case, the fluid amount characteristic is the characteristic of the fluid amount with respect to the detected value from the hydraulic pressure detection portion. Therefore, even when the fluid amount-hydraulic pressure characteristic is changed according to the change in the caliper, the rotor, the pipe layout, the outside temperature, the fluid temperature, the empirical pressure, or the like, the fluid amount control circuit can control the fluid amount supply device in consideration of this change. As a result, the fluid amount control circuit can improve the accuracy of controlling the wheel cylinder pressure using the fluid amount supply device.

(8) An eighth configuration is a fluid amount control circuit. The fluid amount control circuit is configured to drive a fluid amount supply device disposed between a master cylinder and a wheel cylinder to control a fluid amount to supply to the wheel cylinder. The fluid amount control circuit stores a fluid amount characteristic, which is a characteristic of the fluid amount with respect to a hydraulic pressure in the master cylinder, and controls the fluid amount to supply to the wheel cylinder based on the fluid amount characteristic.

According to this eighth configuration, the fluid amount control circuit can control the fluid amount supply device based on the stored fluid amount characteristic. Therefore, even when the fluid amount-hydraulic pressure characteristic is changed according to the change in the caliper, the rotor, the pipe layout, the outside temperature, the fluid temperature, the empirical pressure, or the like, the fluid amount control circuit can control the fluid amount supply device in consideration of this change. As a result, the fluid amount control circuit can improve the accuracy of controlling the wheel cylinder pressure using the fluid amount supply device.

(9) As a ninth configuration, in the eighth configuration, the fluid amount control circuit controls the fluid amount to supply to the wheel cylinder based on the fluid amount characteristic when a target hydraulic pressure corresponding to a braking instruction cannot be generated with use of an electric actuator. Driving of the electric actuator is controlled in such a manner that the target hydraulic pressure corresponding to the braking instruction is generated in the master cylinder.

According to this ninth configuration, the fluid amount control circuit can control the fluid amount supply device in consideration of the change in the fluid amount-hydraulic pressure characteristic when the hydraulic pressure corresponding to the braking instruction cannot be generated with use of the electric actuator. As a result, the fluid amount control circuit can accurately perform the backup control using the fluid amount supply device, i.e., the control of the wheel cylinder pressure using the fluid amount supply device even when a failure has occurred in the electric actuator or the hydraulic pressure control circuit.

Having described several embodiments of the present invention, the above-described embodiments of the present invention are intended to only facilitate the understanding of the present invention, and are not intended to limit the present invention thereto. The present invention can be modified or improved without departing from the spirit of the present invention, and includes equivalents thereof. Further, the individual components described in the claims and the specification can be arbitrarily combined or omitted within a range that allows them to remain capable of achieving at least a part of the above-described objects or producing at least a part of the above-described advantageous effects.

The present application claims priority under the Paris Convention to Japanese Patent Application No. 2018-62129 filed on Mar. 28, 2018. The entire disclosure of Japanese Patent Application No. 2018-62129 filed on Mar. 28, 2018 including the specification, the claims, the drawings, and the abstract is incorporated herein by reference in its entirety.

### REFERENCE SIGN LIST

3FL, 3RR, 3FR, 3RL wheel cylinder
5 electric brake control apparatus (electric brake system)
6 master cylinder
16 electric motor (electric actuator)
25 master cylinder pressure control unit (hydraulic pressure control circuit)
25D memory (storage circuit)
31 wheel cylinder pressure control mechanism (fluid amount supply device)
43A master cylinder pressure sensor (hydraulic pressure detection portion)
44 wheel cylinder pressure control unit (fluid amount control circuit)
44G memory (storage circuit)

1. An electric brake system comprising:
a hydraulic pressure control circuit configured to acquire a detected value from a hydraulic pressure detection portion configured to detect a hydraulic pressure in a master cylinder, and control driving of an electric actuator in such a manner that a target hydraulic pressure corresponding to a braking instruction is generated in the master cylinder;
a fluid amount control circuit configured to drive a fluid amount supply device disposed between the master cylinder and a wheel cylinder to control a fluid amount to supply to the wheel cylinder; and
a storage circuit configured to store a fluid amount characteristic, which is a characteristic of the fluid amount with respect to the detected value,
wherein the fluid amount control circuit controls the fluid amount supply device based on the fluid amount characteristic stored in the storage circuit.

2. The electric brake system according to claim 1, wherein the fluid amount control circuit controls the fluid amount supply device based on the fluid amount characteristic when the target hydraulic pressure corresponding to the braking instruction cannot be generated by the electric actuator.

3. The electric brake system according to claim 2, wherein the hydraulic pressure control circuit transmits the fluid amount characteristic to the fluid amount control circuit when the target hydraulic pressure corresponding to the braking instruction cannot be generated by the electric actuator.

4. The electric brake system according to claim 1, wherein the fluid amount characteristic at the time of a last startup is stored in a nonvolatile memory.

5. The electric brake system according to claim 1, wherein the fluid amount characteristic is stored in the storage circuit on a hydraulic pressure control circuit side.

6. The electric brake system according to claim 1, wherein the fluid amount characteristic is stored in the storage circuit on a fluid amount control circuit side.

7. A hydraulic pressure control circuit:
wherein the hydraulic pressure control circuit is configured to acquire a detected value from a hydraulic pressure detection portion configured to detect a hydraulic pressure in a master cylinder, and control driving of an electric actuator in such a manner that a target hydraulic pressure corresponding to a braking instruction is generated in the master cylinder; and
wherein the hydraulic pressure control circuit transmits a fluid amount characteristic to a fluid amount control circuit,
the fluid amount control circuit being configured to drive a fluid amount supply device,
the fluid amount supply device being disposed between the master cylinder and a wheel cylinder, and
the fluid amount control circuit being configured to store the fluid amount characteristic, which is a characteristic of a fluid amount with respect to the detected value.

8. A fluid amount control circuit:
wherein the fluid amount control circuit is configured to drive a fluid amount supply device disposed between a master cylinder and a wheel cylinder to control a fluid amount to supply to the wheel cylinder; and
wherein the fluid amount control circuit stores a fluid amount characteristic, which is a characteristic of the fluid amount with respect to a hydraulic pressure in the master cylinder, and controls the fluid amount to supply to the wheel cylinder based on the fluid amount characteristic.

9. The fluid amount control circuit according to claim 8, wherein the fluid amount control circuit controls the fluid amount to supply to the wheel cylinder based on the fluid amount characteristic when a target hydraulic pressure corresponding to a braking instruction cannot be generated by an electric actuator, driving of the electric actuator being controlled in such a manner that the target hydraulic pressure corresponding to the braking instruction is generated in the master cylinder.

10. The electric brake system according to claim 2, wherein the fluid amount characteristic at the time of a last startup is stored in a nonvolatile memory.

11. The electric brake system according to claim 3, wherein the fluid amount characteristic at the time of a last startup is stored in a nonvolatile memory.
